(19) United States
(12) Patent Application Publication
(10) Pub. No.: US 2025/0372999 A1
(43) Pub. Date: Dec. 4, 2025

(54) POTENTIAL GENERATING CIRCUIT, REVERSE FLOW PREVENTING CIRCUIT, AND CONTROL METHOD OF POTENTIAL GENERATING CIRCUIT

(71) Applicant: Wacom Co., Ltd., Saitama (JP)

(72) Inventor: Akinobu ONISHI, Saitama (JP)

(73) Assignee: Wacom Co., Ltd., Saitama (JP)

(21) Appl. No.: 19/298,620

(22) Filed: Aug. 13, 2025

Related U.S. Application Data
(63) Continuation of application No. PCT/JP2023/006451, filed on Feb. 22, 2023.

(51) Int. Cl. H02H 3/00; H02M 3/158

(52) U.S. Cl. CPC H02H 3/003; H02M 3/158

(57) ABSTRACT

A potential generating circuit includes a first output circuit configured to output a first signal, a second output circuit configured to output a second signal different from the first signal, and a control circuit configured to control the first output circuit and the second output circuit to make a signal output from one of the first output circuit and the second output circuit according to a combination of a magnitude relation between a potential of the first signal and a first set potential and a magnitude relation between a potential of the second signal and a second set potential.

### BACKGROUND

### Technical Field

The present disclosure relates to a potential generating circuit, a reverse flow preventing circuit, and a control method of the potential generating circuit.

### Description of the Related Art

A potential generating circuit is known, which can generate a plurality of output potentials.

U.S. Pat. No. 7,432,614 discloses an electric circuit that includes a plurality of output nodes, a plurality of switches each connected to a corresponding output node among the plurality of output nodes, and a control circuit that controls, by controlling the turning on/off of the switches, a timing of outputting a potential from each output node.

However, with the technology described in U.S. Pat. No. 7,432,614, in a case where there is difference between loads connected to the plurality of output nodes, the potential of an output node connected to a larger load takes more time to reach a set potential, and further, the potential of the output node tends to decrease. Moreover, with the technology described in U.S. Pat. No. 7,432,614, there is a possibility of a reverse flow of a current from an output side to an internal side of the circuit in a process of generating a plurality of potentials.

### BRIEF SUMMARY

In view of the related art, the present disclosure is directed to a potential generating circuit and a control method of the potential generating circuit, which can generate predetermined set potentials in a short period of time.

A potential generating circuit according to a first aspect of the present disclosure includes a first output circuit configured to output a first signal, a second output circuit configured to output a second signal different from the first signal, and a control circuit configured to control the first output circuit and the second output circuit to make a signal output from one of the first output circuit and the second output circuit according to a combination of a magnitude relation between a potential of the first signal and a first set potential and a magnitude relation between a potential of the second signal and a second set potential.

In a potential generating circuit according to a second aspect of the present disclosure, the control circuit, when the potential of the first signal is equal to or higher than the first set potential and the potential of the second signal is lower than the second set potential, sets an output mode to a fixed output mode and makes the second signal output from the second output circuit. The control circuit, when the potential of the second signal is equal to or higher than the second set potential and the potential of the first signal is lower than the first set potential, sets the output mode to the fixed output mode and makes the first signal output from the first output circuit.

In a potential generating circuit according to a third aspect of the present disclosure, the control circuit, when the potential of the first signal is lower than the first set potential and the potential of the second signal is lower than the second set potential, sets the output mode to an alternating output mode and alternately switches between the output of the first signal by the first output circuit and the output of the second signal by the second output circuit at fixed intervals.

In a potential generating circuit according to a fourth aspect of the present disclosure, in a case where the output mode is the alternating output mode, the control circuit switches the output mode from the alternating output mode to the fixed output mode at a timing of switching between the outputs of the first output circuit and the second output circuit when the potential of the first signal becomes equal to or higher than the first set potential or the potential of the second signal becomes equal to or higher than the second set potential.

A control method of a potential generating circuit according to a fifth aspect of the present disclosure relates to the potential generating circuit including a first output circuit and a second output circuit. The control method includes, by the potential generating circuit, determining whether or not a combination of a magnitude relation between a potential of a first signal and a first set potential and a magnitude relation between a potential of a second signal and a second set potential satisfies a predetermined condition. The control method includes, by the potential generating circuit, controlling the first output circuit and the second output circuit to make a signal output from one of the first output circuit and the second output circuit when the determination is a positive determination. The control method includes, by the potential generating circuit, alternately switching between an output of the first signal by the first output circuit and an output of the second signal by the second output circuit at fixed intervals when the determination is a negative determination.

A reverse flow preventing circuit according to a sixth aspect of the present disclosure includes an output circuit, which has a source terminal, a drain terminal, a gate terminal, and a back gate terminal, which operates in a first state in which a first potential is supplied to the source terminal and in a second state in which a second potential higher than the first potential is supplied to the source terminal, and which outputs a potential supplied to the source terminal from the drain terminal on a basis of a potential of the gate terminal. The reverse flow preventing circuit includes a control circuit, which is connected to the gate terminal, the source terminal, and the back gate terminal. The control circuit, in the first state, controls the potential of the gate terminal so as to stop the output from the output circuit and controls a potential of the back gate terminal such that the potential of the back gate terminal becomes equal to a potential of the drain terminal, and, in the second state, controls the potential of the back gate terminal such that the potential of the back gate terminal becomes equal to the potential of the source terminal.

In a reverse flow preventing circuit according to a seventh aspect of the present disclosure, the output circuit includes a first short-circuiting control circuit having two terminals, which are short-circuited in the first state and which are opened in the second state, wherein one of the two terminals is connected to the back gate terminal and the other of the two terminals is connected to the drain terminal. The output circuit includes a second short-circuiting control circuit having two terminals, which are opened in the first state and which are short-circuited in the second state, wherein one of the two terminals is connected to the back gate terminal and the other of the two terminals is connected to the source terminal.

According to the first to fifth aspects of the present disclosure, predetermined set potentials can be generated in a short period of time. According to the sixth to eighth aspects of the present disclosure, a reverse flow of a current of the output circuit can be prevented.

### BRIEF DESCRIPTION OF THE SEVERAL VIEWS OF THE DRAWINGS

FIG. 1 is a diagram illustrating an example of a power supply circuit;

FIG. 2 is a diagram illustrating an example of a potential generating circuit;

FIG. 3 is a diagram illustrating an example of a configuration of output circuits together with other circuits in the potential generating circuit;

FIG. 4 is a diagram illustrating an example of a constant voltage circuit;

FIG. 5A is a diagram illustrating an example of operation in a first mode of the potential generating circuit;

FIG. 5B is a diagram illustrating an example of operation in a second mode of the potential generating circuit;

FIG. 5C is a diagram illustrating an example of operation in a third mode of the potential generating circuit;

FIG. 5D is a diagram illustrating an example of operation in a fourth mode of the potential generating circuit;

FIG. 5E is a diagram illustrating an example of operation in a fifth mode of the potential generating circuit;

FIG. 6A is a first example of a timing diagram illustrating the states of outputs of the potential generating circuit;

FIG. 6B is a second example of the timing diagram illustrating the states of the outputs of the potential generating circuit;

FIG. 7 is a first example of a timing diagram illustrating transitions of each signal in the potential generating circuit;

FIG. 8 is a second example of the timing diagram illustrating transitions of each signal in the potential generating circuit; and

FIG. 9 is an example of a flowchart illustrating a flow of a series of processing of the potential generating circuit.

### DETAILED DESCRIPTION

An embodiment of the present disclosure (hereinafter referred to as the “present embodiment”) will hereinafter be described with reference to the accompanying drawings. In order to facilitate understanding of the description, identical constituent elements and steps in the drawings will be identified by the same reference signs as much as possible, and repeated description thereof will be omitted.

### Configuration

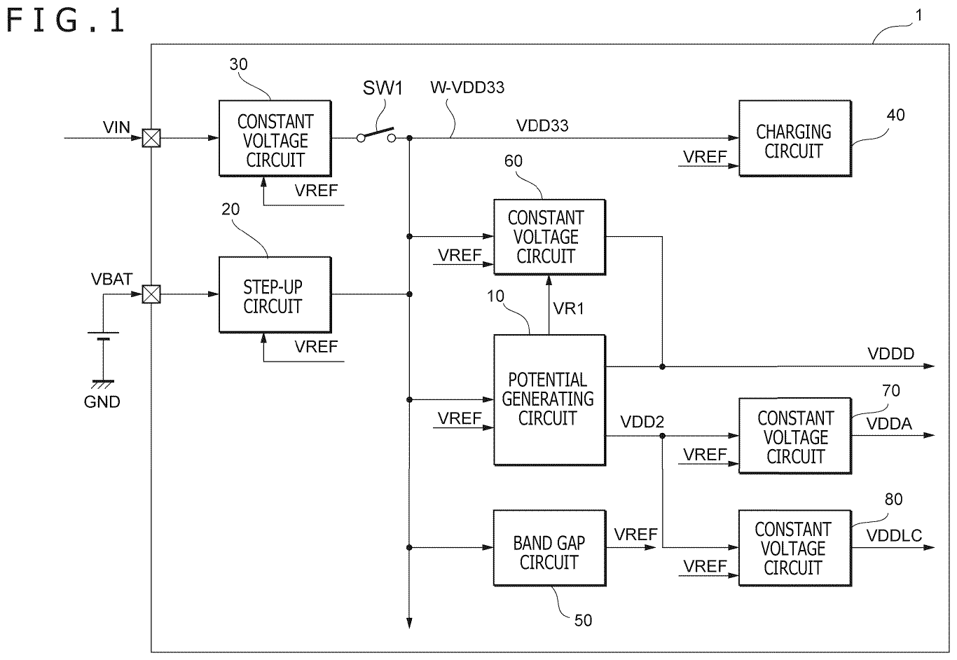

FIG. 1 is a diagram illustrating an example of a power supply circuit 1 according to the present embodiment. The power supply circuit 1 is, for example, mounted in an electronic apparatus such as an active capacitance stylus that can be mounted with a battery and also can be externally supplied with power. The power supply circuit 1 supplies potentials to electric circuits of the stylus.

Specifically, the power supply circuit 1 converts power supplied from a primary battery such as a dry cell and a secondary battery such as a lithium ion battery, as well as power supplied from external power supply paths such as an alternating current (AC) adapter and a universal serial bus (USB), into respective powers corresponding to digital circuits, analog circuits, and LC oscillating circuits. Then, the power supply circuit 1 supplies the converted powers to the digital circuits, the analog circuits, and the LC oscillating circuits. In addition, the power supply circuit 1 charges the mounted secondary battery capable of being charged, such as a lithium ion battery, with the externally supplied power. The power supply circuit 1 includes, for example, a potential generating circuit 10, a step-up circuit 20, constant voltage circuits 30, 60, 70, and 80, a charging circuit 40, and a band gap circuit 50. It is to be noted that the apparatus mounted with the power supply circuit 1 is not limited to the stylus and may be anything as long as the apparatus is a device having an electric circuit.

The constant voltage circuit 30 is, for example, a low dropout (LDO) circuit. The constant voltage circuit 30 converts a potential supplied thereto into a fixed potential of 4.0 V, for example, and outputs the fixed potential. Specifically, the constant voltage circuit 30 converts a potential VIN supplied from an external power supply path such as a USB into a predetermined potential VDD33 on the basis of a reference potential VREF supplied from the band gap circuit 50. The constant voltage circuit 30 supplies the converted potential VDD33 to a power supply line W_VDD33 via a switch SW1.

The switch SW1 is, for example, a transistor, a mechanical switch, or the like. The switch SW1 establishes a short-circuited state or an opened state between the constant voltage circuit 30 and the power supply line W_VDD33 on the basis of the operation of the constant voltage circuit 30. Specifically, when the constant voltage circuit 30 is supplying the potential VDD33 to the power supply line W_VDD33, the switch SW1 establishes a short-circuited state between the constant voltage circuit 30 and the power supply line W_VDD33. In addition, when the constant voltage circuit 30 stops supplying the potential VDD33 to the power supply line W_VDD33, the switch SW1 establishes an opened state between the constant voltage circuit 30 and the power supply line W_VDD33.

The charging circuit 40 is a circuit for charging the lithium ion battery by supplying a potential to the lithium ion battery in a case where the lithium ion battery is used as the battery of the apparatus mounted with the power supply circuit 1. Specifically, the charging circuit 40, on the basis of the reference potential VREF supplied from the band gap circuit 50, converts the potential VDD33 supplied from the constant voltage circuit 30 via the power supply line W_VDD33 into a potential at which the lithium ion battery can be charged. The charging circuit 40 charges the lithium ion battery by supplying the converted potential to the lithium ion battery via a path not illustrated in the figure.

The step-up circuit 20 is, for example, a step-up direct current (DC)-DC converter. The step-up circuit 20 steps up a potential supplied thereto and outputs the potential, or directly outputs the supplied potential. Specifically, in a case where a dry cell is used as the battery of the apparatus mounted with the power supply circuit 1, the step-up circuit 20 steps up a potential VBAT of approximately 0.95 V to approximately 1.60 V supplied from the dry cell to approximately 2.1 V on the basis of the reference potential VREF supplied from the band gap circuit 50, and supplies the stepped-up potential as the potential VDD33 to the power supply line W_VDD33. In addition, in a case where the lithium ion battery is used as the battery of the apparatus mounted with the power supply circuit 1, the step-up circuit 20 supplies the power supply line W_VDD33 with a potential VBAT of approximately 2.80 V to approximately 4.40 V supplied from the lithium ion battery, as the potential VDD33 as it is without stepping up the potential VBAT.

The band gap circuit 50 generates the reference potential VREF, which serves as a reference for each circuit provided in the power supply circuit 1 to operate. The reference potential VREF is a fixed potential at all times which does not depend on the temperature, a power supply voltage, manufacturing process characteristics, or the like. The band gap circuit 50 supplies the generated reference potential VREF to each circuit. Specifically, the band gap circuit 50 generates the reference potential VREF by using, as a power source, the potential VDD33 supplied from the constant voltage circuit 30 or the step-up circuit 20 via the power supply line W_VDD33, and supplies the generated reference potential VREF to each circuit.

The potential generating circuit 10 is a DC-DC converter that can generate a plurality of potentials. The potential generating circuit 10, on the basis of the reference potential VREF output from the band gap circuit 50, generates a potential VDDD of approximately 1.4 V, a potential VDD2 of approximately 2.1 V, and a potential VR1 based on the potential VDD2 from the potential VDD33 supplied from the power supply line W_VDD33. The potential generating circuit 10 supplies the generated potential VDDD to each digital circuit in the power supply circuit 1. In addition, the potential generating circuit 10 supplies the generated potential VDD2 to the constant in voltage circuits 70 and 80. In addition, the potential generating circuit 10 supplies the generated potential VR1 to the constant voltage circuit 60.

The constant voltage circuit 60 is an LDO circuit, for example. The constant voltage circuit 60 converts a potential supplied thereto into a predetermined potential, and outputs the predetermined potential. Specifically, the constant voltage circuit 60 compares the magnitudes of the reference potential VREF supplied from the band gap circuit 50 and the potential VR1 supplied from the potential generating circuit 10 with each other. When the reference potential VREF is equal to or higher than the potential VR1, the constant voltage circuit 60 generates a potential VDDD of 1.35 V to 1.40 V from the potential VDD33 supplied via the power supply line W_VDD33. Then, the constant voltage circuit 30 supplies the generated potential VDDD to each digital circuit in the power supply circuit 1. In addition, when the reference potential VREF is lower than the potential VR1, the constant voltage circuit 60 stops generating and outputting the potential VDDD.

The constant voltage circuits 70 and 80 are each an LDO circuit, for example. The constant voltage circuits 70 and 80 convert a potential supplied thereto into a predetermined potential, and output the predetermined potential. Specifically, the constant voltage circuit 70 converts the potential VDD2 supplied from the potential generating circuit 10 into a potential VDDA of approximately 1.85 V on the basis of the reference potential VREF supplied from the band gap circuit 50. The constant voltage circuit 70 supplies the converted potential VDDA to each analog circuit in the power supply circuit 1. In addition, the constant voltage circuit 80 converts the potential VDD2 supplied from the potential generating circuit 10 into a potential VDDLC of approximately 1.74 V to 2.055 V on the basis of the reference potential VREF supplied from the band gap circuit 50. The constant voltage circuit 80 supplies the converted potential VDDLC to each LC oscillating circuit in the power supply circuit 1.

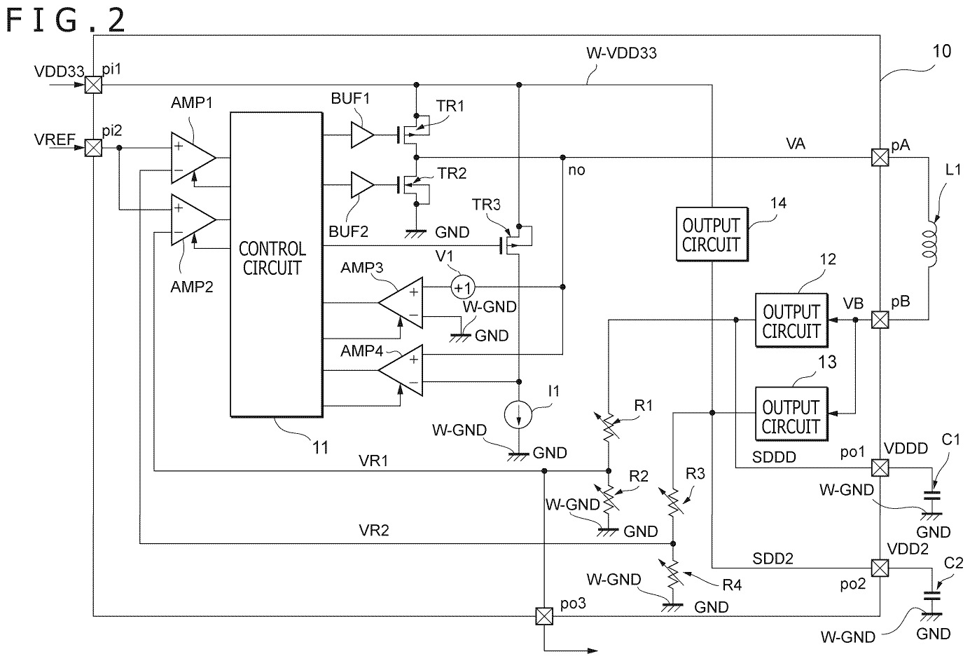

The operation of each circuit in the power supply circuit 1 has been described above. A configuration of the potential generating circuit 10 will next be described. FIG. 2 is a diagram illustrating an example of the potential generating circuit 10. As illustrated in FIG. 2, the potential generating circuit 10 includes a control circuit 11, output circuits 12 to 14, amplifier circuits AMP1 to AMP4, buffer circuits BUF1 and BUF2, transistors TR1 to TR3, variable resistances R1 to R4, a constant voltage source V1, and a constant current source I1. In addition, an inductive element L1 having an inductance of approximately 22 μH is connected between terminals pA and pB of the potential generating circuit 10 via signal lines. A load capacitance C1 is connected, as a load capacitance of an electric circuit, an electric element, or the like connected in a subsequent stage, to a terminal po1 of the potential generating circuit 10. In addition, a load capacitance C2 is connected, as a load capacitance of an electric circuit, an electric element, or the like connected in a subsequent stage, to a terminal po2 of the potential generating circuit 10.

The amplifier circuits AMP1 and AMP2 are each a comparator, for example. The amplifier circuits AMP1 and AMP2 determine whether or not a potential input to a non-inverting input terminal+ thereof is equal to or higher than a potential input to an inverting input terminal− thereof, and transmit a result of the determination to the control circuit 11. Specifically, under control of the control circuit 11, the amplifier circuit AMP1 determines whether or not the reference potential VREF input from the band gap circuit 50 to the non-inverting input terminal+ via a terminal pi2 is equal to or higher than a potential VR2, which is a voltage division potential of variable resistances R3 and R4 input to the inverting input terminal−. The amplifier circuit AMP1 transmits a result of the determination to the control circuit 11. In addition, under control of the control circuit 11, the amplifier circuit AMP2 determines whether or not the reference potential VREF input from the band gap circuit 50 to the non-inverting input terminal+ via the terminal pi2 is equal to or higher than the potential VR1, which is a voltage divided potential of the variable resistances R1 and R2 input to the inverting input terminal−. The amplifier circuit AMP2 transmits a result of the determination to the control circuit 11.

The control circuit 11 transmits signals to the buffer circuits BUF1 and BUF2, to thereby cause a DC-DC converter, formed by the buffer circuits BUF1 and BUF2 and the transistors TR1 and TR2, to output a potential VA, or stop the output of the potential VA.

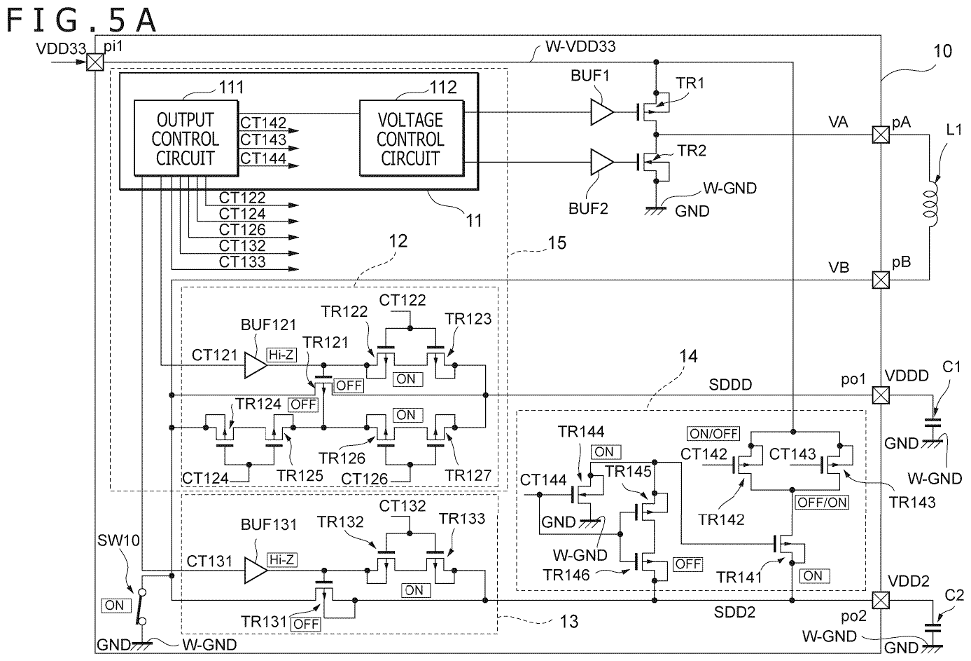

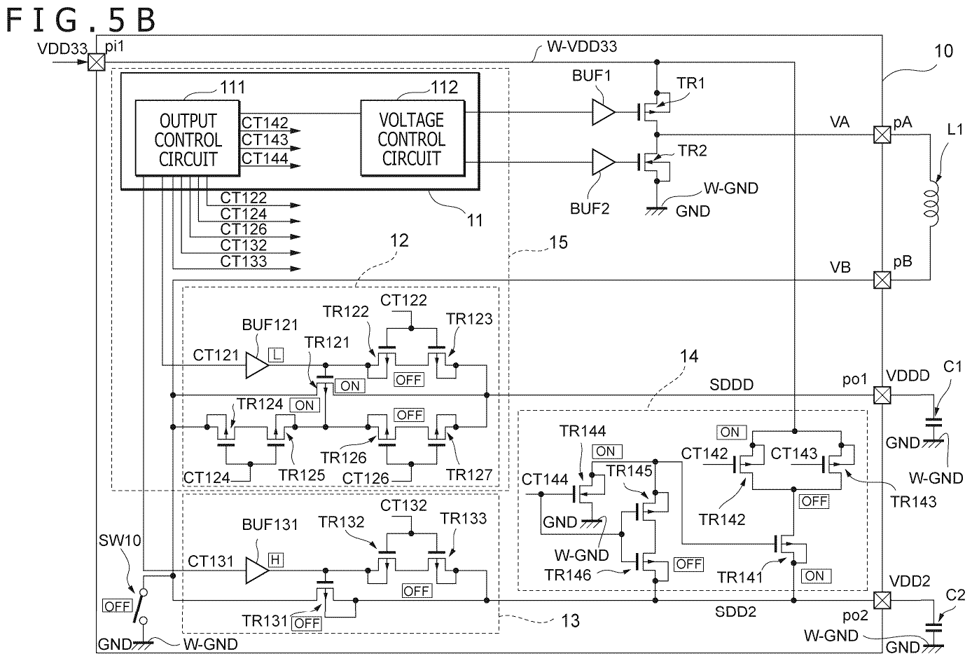

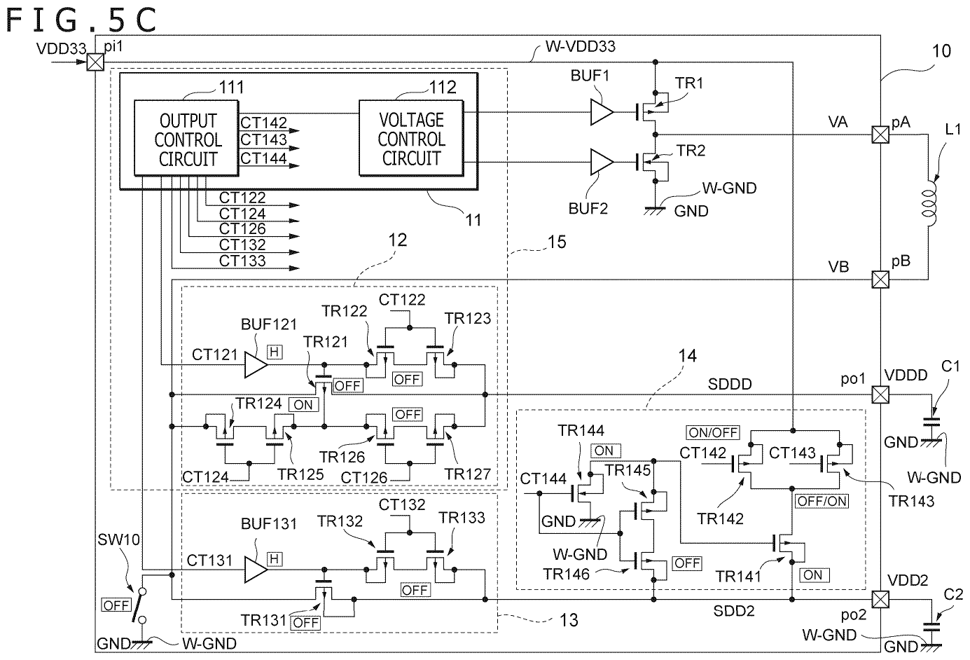

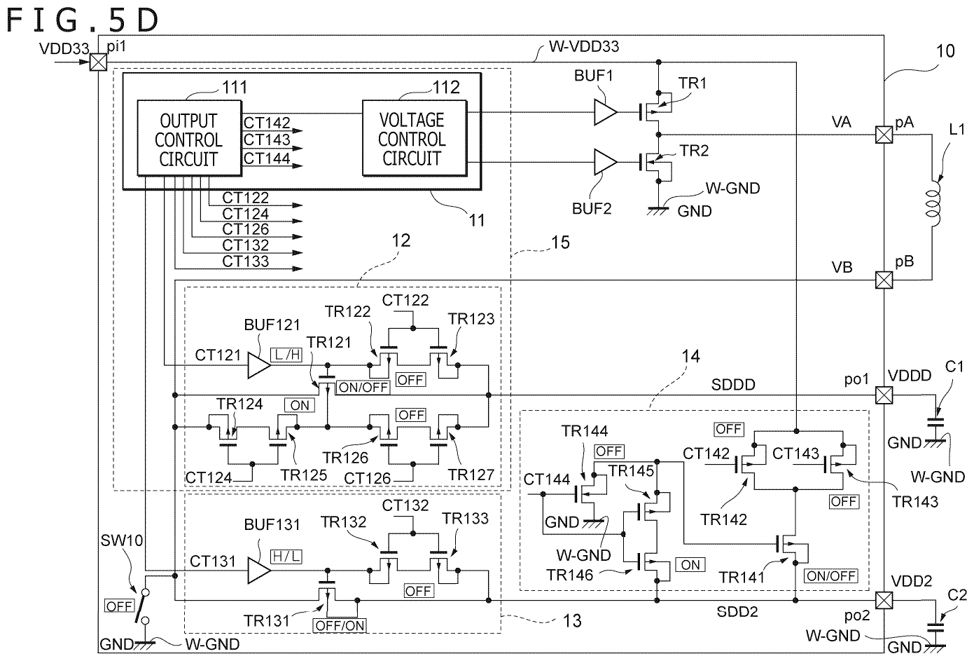

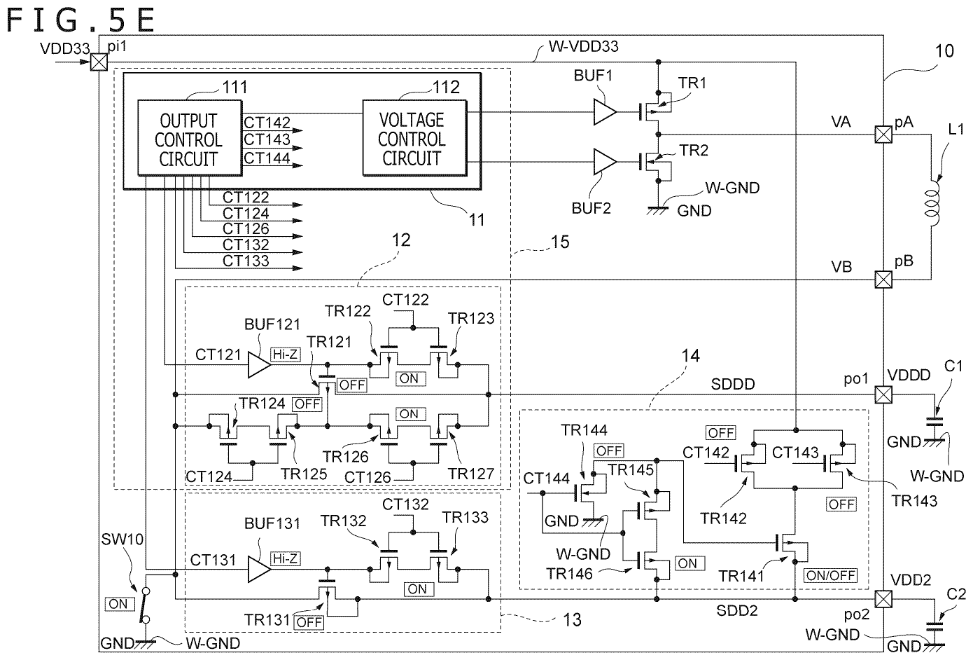

In addition, the control circuit 11 causes the power supply circuit 1 operate in an operation mode as one of first to fifth modes. The control circuit 11 in the fourth mode controls the output circuits 12 and 13 to output a signal from one of the output circuits 12 and 13 according to a combination of a magnitude relation between the potential of a first signal SDDD output from the output circuit 12 and a predetermined first set potential and a magnitude relation between the potential of a second signal SDD2 output from the output circuit 13 and a predetermined second set potential. The control circuit 11 determines the magnitude relation between the first signal SDDD and the first set potential on the basis of the state of output from the amplifier circuit AMP1. In addition, the control circuit 11 determines the magnitude relation between the second signal SDD2 and the second set potential on the basis of the state of output from the amplifier circuit AMP2. Incidentally, the operation of the potential generating circuit 10 in each operation mode will be described later with reference to FIGS. 5A to 5E, and therefore, a description thereof will be omitted here.

The buffer circuits BUF1 and BUF2 are each a buffer circuit including a metal-oxide-semiconductor field-effect transistor (MOS-FET), for example. The buffer circuits BUF1 and BUF2 perform signal enhancement on the signal input to the buffer circuit BUF1, while maintaining logic, and output the signal resulting from the signal enhancement. Specifically, the buffer circuit BUF1 performs the signal enhancement on the signal input from the control circuit 11, while maintaining logic, and outputs the signal resulting from the signal enhancement to a gate terminal of the transistor TR1. In addition, the buffer circuit BUF2 performs the signal enhancement on the signal input from the control circuit 11 to the buffer circuit BUF2, while maintaining logic, and outputs the signal resulting from the signal enhancement to a gate terminal of the transistor TR2.

The transistors TR1 and TR3 are each a P-type MOS-FET, for example. The transistors TR1 and TR3, according to a signal input to a gate terminal thereof, supply a potential supplied to a source terminal thereof to a drain terminal thereof or stop the supply. Specifically, when the state of the signal input to the gate terminal is a low state, the transistors TR1 and TR3 supply the drain terminal with the potential supplied to the source terminal, whereas, when the potential of the signal input to the gate terminal is in a high state, the transistors TR1 and TR3 stop the supply.

The transistor TR1 has the gate terminal thereof connected to an output terminal of the buffer circuit BUF1, has the source terminal thereof connected to the power supply line W_VDD33 via a terminal pi1, and has the drain terminal thereof connected to one end of the inductive element L1 via a node no and the terminal pA.

The transistor TR3 has the gate terminal thereof connected to an output terminal of the control circuit 11 for the transistor TR3, has the source terminal thereof connected to the power supply line W_VDD33 via the terminal pi1, and has the drain terminal thereof connected to a positive electrode terminal of the constant current source I1 and an inverting input terminal− of an amplifier circuit AMP4.

The transistor TR2 is an N-type MOS-FET, for example. The transistor TR2 extracts a charge from a drain terminal thereof to a source terminal thereof or stops the extraction according to the signal input to a gate terminal thereof. Specifically, when the state of the signal input to the gate terminal is a high state, the transistor TR2 extracts a charge from the drain terminal to the source terminal, whereas, when the state of the signal input to the gate terminal is a low state, the transistor TR2 stops the extraction. The transistor TR2 has the gate terminal thereof connected to an output terminal of the buffer circuit BUF2, has the source terminal thereof connected to a grounding wire W_GND, and has the drain terminal thereof connected to the one end of the inductive element L1 via the node no and the terminal pA.

The buffer circuits BUF1 and BUF2 and the transistors TR1 and TR2 function as a DC-DC converter. The DC-DC converter generates the potential VA by alternately selecting conduction and non-conduction between the drain terminals and the source terminals of the transistors TR1 and TR2 under control of the control circuit 11, and supplies the generated potential VA to the node no. Specifically, while there is conduction between the drain terminal and the source terminal of the transistor TR1 and there is no conduction between the drain terminal and the source terminal of the transistor TR2, the DC-DC converter supplies the potential VDD33 from the power supply line W_VDD33 to the node no via the transistor TR1. In addition, while there is no conduction between the drain terminal and the source terminal of the transistor TR1 and there is conduction between the drain terminal and the source terminal of the transistor TR2, the DC-DC converter extracts a potential from the node no to the grounding wire W_GND via the transistor TR2.

The constant voltage source V1 is a voltage source that generates a voltage such that a potential difference between a positive electrode terminal and a negative electrode terminal thereof is a predetermined direct-current voltage and that supplies the generated direct-current voltage. The constant voltage source V1 has the positive electrode terminal thereof connected to a non-inverting input terminal+ of an amplifier circuit AMP3, and has the negative electrode terminal thereof connected to the node no.

The constant current source I1 is a current source that generates a direct current such that a predetermined direct current flows from a positive electrode terminal thereof to a negative electrode terminal thereof under control of the control circuit 11 and that supplies the generated direct current. The constant current source I1 has the positive electrode terminal thereof connected to the inverting input terminal− of the amplifier circuit AMP4 and the drain terminal of the transistor TR3, and has the negative electrode terminal thereof connected to the grounding wire W_GND.

The amplifier circuit AMP3 is a comparator, for example. The amplifier circuit AMP3 in performs a zero cross detection that detects a timing at which a potential input to a non-inverting input terminal+ thereof exceeds a ground potential GND input to an inverting input terminal− thereof or falls below the ground potential GND. Specifically, the amplifier circuit AMP3 determines under control of the control circuit 11 whether or not the potential input from the constant voltage source V1 to the non-inverting input terminal+ is equal to or higher than the ground potential GND of the grounding wire W_GND input to the inverting input terminal−. The amplifier circuit AMP3 transmits a result of the determination to the control circuit 11.

The amplifier circuit AMP4 is a comparator, for example. The amplifier circuit AMP4 performs a peak current detection that detects a timing at which a current flowing through a current path connected to a non-inverting input terminal+ thereof becomes equal to or larger than a predetermined current flowing through a current path connected to an inverting input terminal− thereof. Specifically, the amplifier circuit AMP4 determines under control of the control circuit 11 whether or not the potential VA input from the drain terminals of the transistors TR1 and TR2 to the non-inverting input terminal+ is equal to or higher than the potential, to be inputted to the inverting input terminal−, of the drain terminal of the transistor TR3 and the positive electrode terminal of the constant current source I1. The amplifier circuit AMP4 transmits a result of the determination to the control circuit 11.

Under control of the control circuit 11, the output circuit 12 outputs, as the first signal SDDD, a potential VB supplied from the terminal pB, or stops the output. Incidentally, the output circuit 12 operates in an operation mode as one of an LDO mode, a DC-DC mode, and a standby mode. Details of the operation in each operation mode of the output circuit 12 will be described later with reference to FIGS. 5A to 5E, and therefore a description thereof will be omitted here.

Under control of the control circuit 11, the output circuit 13 outputs, as the second signal SDD2, the potential VB supplied from the terminal pB, or stops the output. Details of the operation of the output circuit 13 will be described later with reference to FIGS. 5A to 5E, and therefore, a description thereof will be omitted here.

Under control of the control circuit 11, the output circuit 14 outputs, as the second signal SDD2, the potential VDD33 supplied from the power supply line W_VDD33, or stops the output. Incidentally, the output circuit 14 operates in an operation mode as one of a current limiting mode, a through mode, a DC-DC mode, and a standby mode. Details of the operation in each operation mode of the output circuit 14 will be described later with reference to FIGS. 5A to 5E, and therefore, a description thereof will be omitted here.

The variable resistances R1 to R4 are each a resistive element that allows a resistance value across both ends thereof to be changed. The variable resistances R1 to R4 have the resistance values thereof changed under control of the control circuit 11.

The variable resistances R1 and R2 function as a voltage dividing circuit. The variable resistances R1 and R2 voltage-divide the potential VDDD output from the output circuit 12 by the resistance values of the variable resistances R1 and R2, output the voltage-divided potential VR1 to the inverting input terminal− of the amplifier circuit AMP2, and output the potential VR1 to the constant voltage circuit 60 via a terminal po3. The variable resistance R1 has one end connected to an output terminal of the output circuit 12 and the terminal po1, and has another end connected to one end of the variable resistance R2, the inverting input terminal− of the amplifier circuit AMP2, and the terminal po3. The variable resistance R2 has one end connected to the other end of the variable resistance R1, the inverting input terminal− of the amplifier circuit AMP2, and the terminal po3, and has another end connected to the grounding wire W_GND.

The variable resistances R3 and R4 function as a voltage dividing circuit. The variable resistances R3 and R4 voltage-divide the potential VDD2 output from the output circuit 13 or 14 by the resistance values of the variable resistances R3 and R4, and output the voltage-divided potential VR2 to the inverting input terminal− of the amplifier circuit AMP1. The variable resistance R3 has one end connected to an output terminal of the output circuit 13, an output terminal of the output circuit 14, and the terminal po2, and has another end connected to one end of the variable resistance R4 and the inverting input terminal− of the amplifier circuit AMP1. The variable resistance R4 has one end connected to the other end of the variable resistance R3 and the inverting input terminal− of the amplifier circuit AMP1, and has another end connected to the grounding wire W_GND.

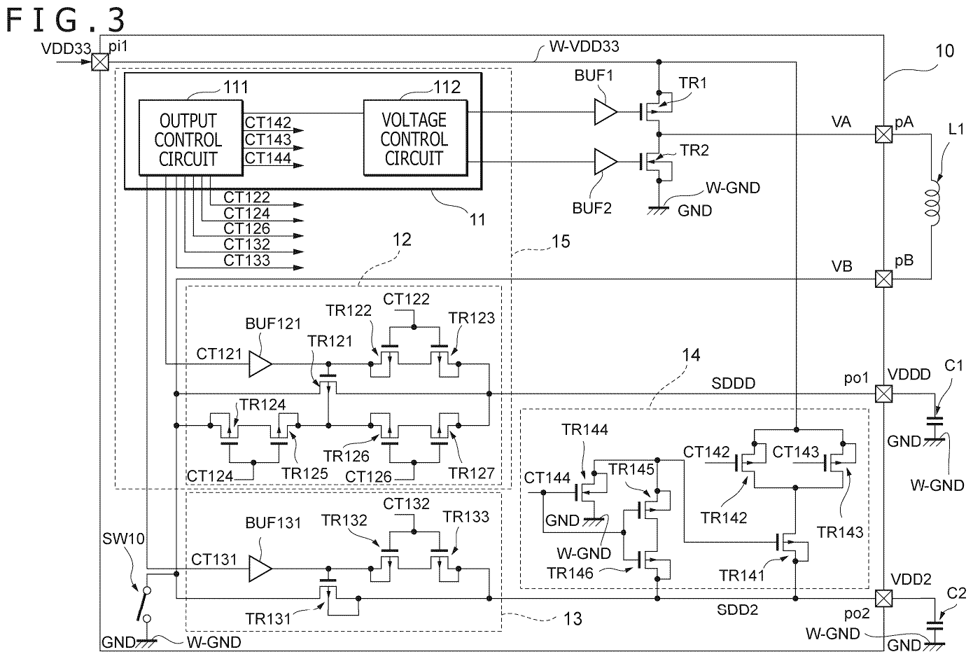

A configuration of the output circuits 12 to 14 in the potential generating circuit 10 will next be described. FIG. 3 is a diagram illustrating an example of the configuration of the output circuits 12 to 14 together with other circuits in the potential generating circuit 10. As illustrated in FIG. 3, the control circuit 11 includes, for example, an output control circuit 111 and a voltage control circuit 112.

The output control circuit 111 controls the output circuits 12 to 14 and a switch SW10. Specifically, the output control circuit 111 transmits control signals CT121, CT122, CT124, and CT126 to the output circuit 12, and thereby controls operation of the output circuit 12. In addition, the output control circuit 111 transmits control signals CT131 and CT132 to the output circuit 13, and thereby controls operation of the output circuit 13. In addition, the output control circuit 111 transmits control signals CT142 to CT144 to the output circuit 14, and thereby controls operation of the output circuit 14. In addition, the output control circuit 111 communicates an instruction to the voltage control circuit 112 to output the potential VA or stop the output.

According to the instruction transmitted from the output control circuit 111, the voltage control circuit 112 transmits signals to the buffer circuits BUF1 and BUF2 of the DC-DC converter formed by the buffer circuits BUF1 and BUF2 and the transistors TR1 and TR2, such that the DC-DC converter outputs the potential VA or stops the output.

The output circuit 12 includes, for example, transistors TR121 to TR127 and a buffer circuit BUF121. In addition, the output circuit 12 forms a reverse flow preventing circuit 15 together with the control circuit 11.

The buffer circuit BUF121 is, for example, a buffer circuit including a MOS-FET. The buffer circuit BUF121 performs signal enhancement on the signal input thereto, while maintaining logic, and outputs the signal resulting from the signal enhancement. Specifically, the buffer circuit BUF121 performs the signal enhancement on the control signal CT121 transmitted from the output control circuit 111, while maintaining logic, and outputs the signal resulting from the signal enhancement to a gate terminal of the transistor TR121 and a source terminal of the transistor TR122.

Transistors TR121 to TR127, TR131 to TR133, TR141 to TR143, TR145, and TR146 are each a P-type MOS-FET, for example. The transistors TR121 to TR127, TR131 to TR133, TR141 to TR143, TR145, and TR146 supply a drain terminal thereof with a potential supplied to a source terminal thereof or stop the supply according to a signal input to a gate terminal thereof. Specifically, when the state of the signal input to the gate terminal is a low state, the transistors TR121 to TR127, TR131 to TR133, TR141 to TR143, TR145, and TR146 supply the drain terminal with the potential supplied to the source terminal, whereas, when the potential of the signal input to the gate terminal is a high state, the transistors TR121 to TR127, TR131 to TR133, TR141 to TR143, TR145, and TR146 stop the supply. The transistors TR122 to TR127, TR131 to TR133, TR141 to TR143, TR145, and TR146 except the transistor TR121 have a back gate terminal thereof connected to the source terminal.

The transistor TR121 has the gate terminal thereof connected to an output terminal of the buffer circuit BUF121 and to the source terminal of the transistor TR122, and has the source terminal thereof connected to another end of the inductive element L1 via the terminal pB, to the source terminal of the transistor TR124, to the drain terminal of the transistor TR131, and to one terminal of the switch SW10. In addition, the transistor TR121 has the drain terminal thereof connected to one end of the load capacitance C1 via the terminal po1 and to the source terminals of the transistors TR123 and TR127, and has the back gate terminal thereof connected to the source terminals of the transistors TR124 and TR126.

The control signal CT122 transmitted from the output control circuit 111 is input to the gate terminal of the transistor TR122. In addition, the transistor TR122 has the source terminal thereof connected to the gate terminal of the transistor TR121 and to the output terminal of the buffer circuit BUF121, and has the drain terminal thereof connected to the drain terminal of the transistor TR123.

The control signal CT122 transmitted from the output control circuit 111 is input to the gate terminal of the transistor TR123. In addition, the transistor TR123 has the source terminal thereof connected to the one end of the load capacitance C1 via the terminal po1, to the drain terminal of the transistor TR121, and to the source terminal of the transistor TR127, and has the drain terminal thereof connected to the drain terminal of the transistor TR122.

The control signal CT124 transmitted from the output control circuit 111 is input to the gate terminal of the transistor TR124. In addition, the transistor TR124 has the source terminal thereof connected to the other end of the inductive element L1 via the terminal pB, to the source terminal of the transistor TR121, to the drain terminal of the transistor TR131, and to the one terminal of the switch SW10. In addition, the transistor TR124 has the drain terminal thereof connected to the drain terminal of the transistor TR125. The transistor TR124 forms a first short-circuiting control circuit together with the transistor TR125.

The control signal CT124 transmitted from the output control circuit 111 is input to the gate terminal of the transistor TR125. In addition, the transistor TR125 has the source terminal thereof connected to the back gate terminal of the transistor TR121 and to the source terminal of the transistor TR126, and has the drain terminal thereof connected to the drain terminal of the transistor TR124. The transistor TR125 and the transistor TR124 form the first short-circuiting control circuit.

The control signal CT126 transmitted from the output control circuit 111 is input to the gate terminal of the transistor TR126. In addition, the transistor TR126 has the source terminal thereof connected to the back gate terminal of the transistor TR121 and to the source terminal of the transistor TR125, and has the drain terminal thereof connected to the drain terminal of the transistor TR127. The transistor TR126 forms a second short-circuiting control circuit together with the transistor TR127.

The control signal CT126 transmitted from the output control circuit 111 is input to the gate terminal of the transistor TR127. In addition, the transistor TR127 has the source terminal thereof connected to the one end of the load capacitance C1 via the terminal po1, to the drain terminal of the transistor TR121, and to the source terminal of the transistor TR123, and has the drain terminal thereof connected to the drain terminal of the transistor TR126. The transistor TR127 forms the second short-circuiting control circuit together with the transistor TR126.

The output circuit 13 includes, for example, the transistors TR131 to TR133 and a buffer circuit BUF131.

The buffer circuit BUF131 is, for example, a buffer circuit including a MOS-FET. The buffer circuit BUF131 performs signal enhancement on the signal input thereto, while maintaining logic, and outputs the signal resulting from the signal enhancement. Specifically, the buffer circuit BUF131 performs the signal enhancement on the control signal CT131 transmitted from the output control circuit 111, while maintaining logic, and outputs the signal resulting from the signal enhancement to the gate terminal of the transistor TR131 and the source terminal of the transistor TR132.

The transistor TR131 has the gate terminal thereof connected to an output terminal of the buffer circuit BUF131 and the source terminal of the transistor TR132. In addition, the transistor TR131 has the source terminal thereof connected to one end of the load capacitance C2 via the terminal po2, and to the source terminals of the transistors TR133, TR141, and TR146. In addition, the transistor TR131 has the drain terminal thereof connected to the other end of the inductive element L1 via the terminal pB, to the source terminals of the transistors TR121 and TR124, and to the one terminal of the switch SW10.

The control signal CT132 transmitted from the output control circuit 111 is input to the gate terminal of the transistor TR132. In addition, the transistor TR132 has the source terminal thereof connected to the output terminal of the buffer circuit BUF131 and the gate terminal of the transistor TR131. In addition, the transistor TR132 has the drain terminal thereof connected to the drain terminal of the transistor TR133.

The control signal CT132 transmitted from the output control circuit 111 is input to the gate terminal of the transistor TR133. In addition, the transistor TR133 has the source terminal thereof connected to the one end of the load capacitance C2 via the terminal po2 and to the source terminals of the transistors TR131, TR141, and TR146. In addition, the transistor TR133 has the drain terminal thereof connected to the drain terminal of the transistor TR132.

The output circuit 14 includes, for example, transistors TR141 to TR146.

The transistor TR141 has the gate terminal thereof connected to the source terminals of the transistors TR144 and TR145. In addition, the transistor TR141 has the source terminal thereof connected to the one end of the load capacitance C2 via the terminal po2 and to the source terminals of the transistors TR131, TR133, and TR146. In addition, the transistor TR141 has the drain terminal thereof connected to the drain terminals of the transistors TR142 and TR143.

The control signal CT142 transmitted from the output control circuit 111 is input to the gate terminal of the transistor TR142. In addition, the transistor TR142 has the source terminal thereof connected to the power supply line W_VDD33 via the terminal pi1 and to the source terminals of the transistors TR1 and TR143. In addition, the transistor TR142 has the drain terminal thereof connected to the drain terminals of the transistors TR141 and TR143.

The control signal CT143 transmitted from the output control circuit 111 is input to the gate terminal of the transistor TR143. In addition, the transistor TR143 has the source terminal thereof connected to the power supply line W_VDD33 via the terminal pi1 and to the source terminals of the transistors TR1 and TR142. In addition, the transistor TR143 has the drain terminal thereof connected to the drain terminals of the transistors TR141 and TR142.

The transistor TR144 is an N-type MOS-FET, for example. The transistor TR144 extracts a charge from a drain terminal thereof to a source terminal thereof or stops the extraction according to the signal input to a gate terminal thereof. Specifically, when the state of the signal input to the gate terminal is a high state, the transistor TR144 extracts a charge from the drain terminal to the source terminal, whereas, when the state of the signal input to the gate terminal is a low state, the transistor TR144 stops the extraction. Specifically, the control signal CT144 transmitted from the output control circuit 111 is input to the gate terminal of the transistor TR144. In addition, the transistor TR144 has the source terminal thereof connected to the source terminal of the transistor TR145 and the gate terminal of TR141. In addition, the transistor TR144 has the drain terminal thereof connected to the grounding wire W_GND.

The control signal CT144 transmitted from the output control circuit 111 is input to the gate terminal of the transistor TR145. In addition, the transistor TR145 has the source terminal thereof connected to the source terminal of the transistor TR144 and the gate terminal of TR141. In addition, the transistor TR145 has the drain terminal thereof connected to the drain terminal of the transistor TR146.

The control signal CT144 transmitted from the output control circuit 111 is input to the gate terminal of the transistor TR146. In addition, the transistor TR146 has the source terminal thereof connected to the one end of the load capacitance C2 via the terminal po2 and to the source terminals of the transistors TR131, TR133, and TR141. In addition, the transistor TR146 has the drain terminal thereof connected to the drain terminal of the transistor TR145.

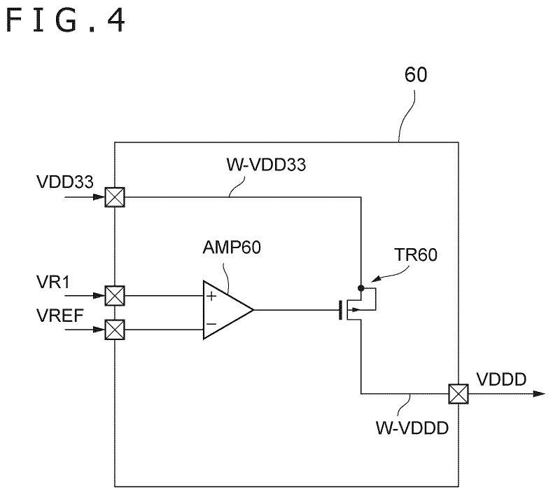

A configuration of the constant voltage circuit 60 will next be described. FIG. 4 is a diagram illustrating an example of the constant voltage circuit 60. As illustrated in FIG. 4, the constant voltage circuit 60 includes, for example, an amplifier circuit AMP60 and a transistor TR60.

The amplifier circuit AMP60 is a comparator, for example. The amplifier circuit AMP60 determines whether or not a potential input to a non-inverting input terminal+ thereof is equal to or higher than a potential input to an inverting input terminal− thereof. The amplifier circuit AMP60 outputs a result of the determination to the transistor TR60. Specifically, the amplifier circuit AMP60 determines whether or not the potential VR1 input from the potential generating circuit 10 to the non-inverting input terminal+ is equal to or higher than the reference potential VREF input from the band gap circuit 50 to the inverting input terminal−. When a result of the determination is a positive determination, the amplifier circuit AMP60 outputs a signal in a high state to a gate terminal of the transistor TR60. In addition, when the result of the determination is a negative determination, the amplifier circuit AMP60 outputs a signal in a low state to the gate terminal of the transistor TR60.

The transistor TR60 is a P-type MOS-FET, for example. The transistor TR60 effects conduction between a source terminal and a drain terminal thereof or sets a state of non-conduction therebetween according to a potential input to the gate terminal thereof. Specifically, when the state of the signal input to the gate terminal is a low state, the transistor TR60 effects conduction between the source terminal and the drain terminal, whereas, when the potential of the signal input to the gate terminal is in a high state, the transistor TR60 sets a state of non-conduction between the source terminal and the drain terminal. When there is conduction between the source terminal and the drain terminal, the transistor TR60 supplies, from the drain terminal, a potential resulting from a voltage drop by a potential difference according to a source-to-drain resistance with respect to a potential supplied to the source terminal.

The transistor TR60 has the gate terminal thereof connected to an output terminal of the amplifier circuit AMP60, has the source terminal thereof connected to the power supply line W_VDD33, and has the drain terminal thereof connected to a power supply line W_VDDD.

### Flow of Series of Operations

A configuration of the power supply circuit 1 has been described above. Next, operation in each mode of the power supply circuit 1 will be described in detail. The output circuit 12 in the power supply circuit 1 operates in an operation mode as one of the LDO mode, the DC-DC mode, and the standby mode. In addition, the output circuit 14 in the power supply circuit 1 operates in an operation mode as one of the current limiting mode, the through mode, the DC-DC mode, and the standby mode.

Further, the power supply circuit 1 switches operation according to whether a dry cell is mounted as a battery in the apparatus mounted with the power supply circuit 1 or whether a lithium ion battery is mounted in the apparatus. A description will be made of a case where a dry cell is mounted in the apparatus mounted with the power supply circuit 1. The power supply circuit 1 first makes the output circuit 12 operate in the LDO mode after a start of the power supply circuit 1, and next makes the output circuit 12 operate in the DC-DC mode. In addition, the power supply circuit 1 first makes the output circuit 14 operate in the current limiting mode after the start of the power supply circuit 1, and next makes the output circuit 14 operate in the through mode. In addition, when the apparatus mounted with the power supply circuit 1 is in a sleep state or the like, the power supply circuit 1 makes the output circuits 12 to 14 operate in the standby mode.

A description will be made of a case where a lithium ion battery is mounted as a battery in the apparatus mounted with the power supply circuit 1. The power supply circuit 1 first makes the output circuit 12 operate in the LDO mode after a start of the power supply circuit 1, and next makes the output circuit 12 operate in the DC-DC mode. In addition, the power supply circuit 1 first makes the output circuit 14 operate in the current limiting mode for a predetermined period of time after the start of the power supply circuit 1, and thereafter makes the output circuit 14 operate in the through mode while the output circuit 12 is operating in the LDO mode. Further, when the output circuit 12 switches the operation mode thereof from the LDO mode to the DC-DC mode, the power supply circuit 1 switches the operation mode of the output circuit 14 from the through mode to the DC-DC mode, and makes the output circuit 14 operate in the DC-DC mode. In addition, when the apparatus mounted with the power supply circuit 1 is in a sleep state or the like, the power supply circuit 1 makes the output circuits 12 to 14 operate in the standby mode.

A description will be made of operation of each circuit in the power supply circuit 1, in a case where a dry cell is mounted as a battery in the apparatus mounted with the power supply circuit 1 and the power supply circuit 1 is operating in the first mode, in which the output circuit 12 operates in the LDO mode. FIG. 5A is a diagram illustrating an example of operation in the first mode of the potential generating circuit 10. In the present embodiment, a state in which there is conduction between the source terminal and the drain terminal of a transistor will be referred to as an on state, and a state in which there is no conduction between the source terminal and the drain terminal of the transistor will be referred to as an off state. In the first mode, the voltage control circuit 112 in the control circuit 11 controls the operation of the DC-DC converter formed by the transistors TR1 and TR2 and the buffer circuits BUF1 and BUF2, in such a manner as to stop the generation of the potential VA. In addition, the output control circuit 111, by performing short-circuiting control of the switch SW10, causes the potential of the terminal pB to transition to the ground potential GND.

In the first mode, the output control circuit 111 in the control circuit 11 transmits the control signal CT121 to the buffer circuit BUF121 such that the state of the signal output from the buffer circuit BUF121 becomes a high-impedance state. In addition, the output control circuit 111 transmits the control signal CT122 in a low state to the gate terminals of the transistors TR122 and TR123, and thereby sets the transistors TR122 and TR123 in an on state. In addition, the output control circuit 111 transmits the control signal CT126 in a low state to the gate terminals of the transistors TR126 and TR127, and thereby sets the transistors TR126 and TR127 in an on state. In addition, the output control circuit 111 transmits the control signal CT124 in a high state to the gate terminals of the transistors TR124 and TR125, and thereby sets the transistors TR124 and TR125 in an off state.

In the first mode, according to the states set in the transistors TR122 to TR127, the gate terminal of the transistor TR121 is supplied with the potential VDDD from the constant voltage circuit 60 via the transistors TR122 and TR123 in an on state and via the terminal po1. In addition, in the first mode, the source terminal of the transistor TR121 is supplied with the ground potential GND via the switch SW10. In addition, in the first mode, the drain terminal of the transistor TR121 is supplied with the potential VDDD from the constant voltage circuit 60 via the terminal po1. Further, the back gate terminal of the transistor TR121 is supplied with the potential VDDD from the constant voltage circuit 60 via the transistors TR126 and TR127 in an on state and via the terminal po1.

In the first mode, the transistor TR121 is set in an off state according to the states of the transistors TR122 to TR127. In addition, in the first mode, because the transistor TR121 has the back gate terminal thereof connected to the drain terminal thereof via the transistors TR126 and TR127, a parasitic diode directed from the source terminal to the drain terminal via the back gate terminal is formed in the transistor TR121. In the first mode, the transistor TR121 conducts in a direction from the source terminal to the drain terminal side, whereas the transistor TR121 does not conduct in a direction from the drain terminal to the source terminal.

Thus, in the first mode, the reverse flow preventing circuit 15 including the output circuit 12 and the control circuit 11 is set in a first state in which the ground potential GND is supplied to the source terminal.

In the first state, though the parasitic diode is conducting in a direction from an input side to an output side in the output circuit 12, the reverse flow preventing circuit 15 prevents a current from flowing from the input side to the output side of the output circuit 12 because the potential of the terminal po1 on the output side is higher than the potential of the terminal pB on the input side. In addition, in the first state, the reverse flow preventing circuit 15 prevents a current from flowing backward from the output side to the input side because the parasitic diode does not conduct in a direction from the output side to the input side in the output circuit 12.

In the first mode, the output control circuit 111 in the control circuit 11 transmits the control signal CT131 to the buffer circuit BUF131 such that the state of the signal output from the buffer circuit BUF131 becomes a high-impedance state. In addition, the output control circuit 111 transmits the control signal CT132 in a low state to the gate terminals of the transistors TR132 and TR133, and thereby sets the transistors TR132 and TR133 in an on state.

In the first mode, the gate terminal of the transistor TR131 is supplied with the potential VDD2 from the output circuit 14 via the transistors TR132 and TR133 in an on state. In addition, in the first mode, the source terminal of the transistor TR131 is supplied with the potential VDD2 from the output circuit 14. In addition, in the first mode, the drain terminal of the transistor TR131 is supplied with the ground potential GND via the switch SW10.

In the first mode, the transistor TR131 is set in an off state according to the states of the transistors TR132 and TR133. In addition, because the transistor TR131 has the back gate terminal thereof connected to the source terminal thereof, a parasitic diode directed from the drain terminal to the source terminal via the back gate terminal is formed in the transistor TR131. The transistor TR131 conducts in a direction from the drain terminal to the source terminal, whereas the transistor TR131 does not conduct in a direction from the source terminal to the drain terminal.

Thus, in the first mode, though the parasitic diode conducts in a direction from an input side to an output side in the output circuit 13, the output circuit 13 prevents a current from flowing from the input side to the output side of the output circuit 13 because the potential of the terminal po2 on the output side is higher than the potential of the terminal pB on the input side. In addition, in the first mode, the output circuit 13 prevents a current from flowing backward from the output side to the input side because the parasitic diode does not conduct in a direction from the output side to the input side in the output circuit 13.

In the first mode, the output control circuit 111 in the control circuit 11 transmits the control signal CT144 in a high state to the gate terminals of the transistors TR144 to TR146, and thereby sets the transistor TR144 in an on state and sets the transistors TR145 and TR146 in an off state. In the first mode, according to the states set in the transistors TR144 to TR146, the gate terminal of the transistor TR141 is supplied with the ground potential GND from the transistor TR144 in an on state via the grounding wire W_GND, and the transistor TR141 is thereby set in an on state. Incidentally, because the transistor TR146 has the back gate terminal thereof connected to the source terminal thereof, the transistor TR146 prevents a current from flowing in a direction from the source terminal to the drain terminal in the first mode.

In addition, when the power supply circuit 1 is in the first mode and the output circuit 14 is in the current limiting mode, the output control circuit 111 transmits the control signal CT142 in a high state to the gate terminal of the transistor TR142, and thereby sets the transistor TR142 in an off state. In addition, when the power supply circuit 1 is in the first mode and the output circuit 14 is in the current limiting mode, the output control circuit 111 transmits the control signal CT143 in a low state to the gate terminal of the transistor TR143, and thereby sets the transistor TR143 in an on state.

Accordingly, when the power supply circuit 1 is in the first mode and the output circuit 14 is in the current limiting mode, the output circuit 14 outputs the potential VDD2 from the power supply line W_VDD33 via the transistors TR143 and TR141 in an on state such that the potential VDD2 is substantially the same as the potential VDD33 of the power supply line W_VDD33. Because an on resistance of the transistor TR143 is higher than an on resistance of the transistor TR142, the output circuit 14 outputs the potential VDD2 to the terminal po2 such that an output current is smaller in the current limiting mode than when the output circuit 14 is operating in the through mode.

In addition, when the power supply circuit 1 is in the first mode and the output circuit 14 is in the through mode, the output control circuit 111 transmits the control signal CT142 in a low state to the gate terminal of the transistor TR142, and thereby sets the transistor TR142 in an on state. In addition, when the power supply circuit 1 is in the first mode and the output circuit 14 is in the through mode, the output control circuit 111 transmits the control signal CT143 in a high state to the gate terminal of the transistor TR143, and thereby sets the transistor TR143 in an off state.

Accordingly, when the power supply circuit 1 is in the first mode and the output circuit 14 is in the through mode, the output circuit 14 outputs the potential VDD2 from the power supply line W_VDD33 via the transistors TR142 and TR141 in an on state such that the potential VDD2 is substantially the same as the potential VDD33 of the power supply line W_VDD33. Because the on resistance of the transistor TR142 is lower than the on resistance of the transistor TR143, the output circuit 14 outputs the potential VDD2 to the terminal po2 such that the output current is larger in the through mode than when the output circuit 14 is operating in the current limiting mode.

A description will be made of operation of each circuit in the power supply circuit 1 in a case where a dry cell is mounted as a battery in the apparatus mounted with the power supply circuit 1 and the power supply circuit 1 is operating in the second mode, in which and the output circuit 12 operates in the DC-DC mode. FIG. 5B is a diagram illustrating an example of operation in the second mode of the potential generating circuit 10. In the second mode, the voltage control circuit 112 in the control circuit 11 controls the operation of the DC-DC converter formed by the transistors TR1 and TR2 and the buffer circuits BUF1 and BUF2, in such a manner as to generate the potential VA. In addition, the output control circuit 111 prevents the terminal pB from being connected to the grounding wire W_GND, by performing opening control of the switch SW10.

In the second mode, the output control circuit 111 in the control circuit 11 transmits the control signal CT121 to the buffer circuit BUF121 such that the state of the signal output from the buffer circuit BUF121 becomes a low state. In addition, the output control circuit 111 transmits the control signal CT122 in a high state to the gate terminals of the transistors TR122 and TR123, and thereby sets the transistors TR122 and TR123 in an off state. In addition, the output control circuit 111 transmits the control signal CT126 in a high state to the gate terminals of the transistors TR126 and TR127, and thereby sets the transistors TR126 and TR127 in an off state. In addition, the output control circuit 111 transmits the control signal CT124 in a low state to the gate terminals of the transistors TR124 and TR125, and thereby sets the transistors TR124 and TR125 in an on state.

In the second mode, according to the states set in the transistors TR122 to TR127, the signal in a low state is input from the buffer circuit BUF121 to the gate terminal of the transistor TR121, and the transistor TR121 is thereby set in an on state. In addition, in the second mode, the source terminal of the transistor TR121 is supplied with the potential VB via the terminal pB, and the output circuit 12 outputs the first signal SDDD from the drain terminal of the transistor TR121 such that the potential VDDD is a first set potential (for example, 1.4 V). Thus, in the second mode, the reverse flow preventing circuit 15 including the control circuit 11 and the output circuit 12 is set in a second state in which the source terminal is supplied with the potential VB. In the second state, in the reverse flow preventing circuit 15, because the back gate terminal of the transistor TR121 is connected to the source terminal thereof via the transistors TR124 and TR125, a parasitic diode directed from the drain terminal to the source terminal via the back gate terminal is formed in the transistor TR121.

In the second mode, the output control circuit 111 in the control circuit 11 transmits the control signal CT131 to the buffer circuit BUF131 such that the state of the signal output from the buffer circuit BUF131 becomes a high state. In addition, the output control circuit 111 transmits the control signal CT132 in a high state to the gate terminals of the transistors TR132 and TR133, and thereby sets the transistors TR132 and TR133 in an off state.

In the second mode, the signal in a high state is input from the buffer circuit BUF131 to the gate terminal of the transistor TR131. In addition, in the second mode, the source terminal of the transistor TR131 is supplied with the potential VDD2 from the output circuit 14. In addition, in the second mode, the drain terminal of the transistor TR131 is supplied with the potential VB of the terminal pB.

In the second mode, the transistor TR131 is set in an off state according to the states of the transistors TR132 and TR133. In addition, because the transistor TR131 has the back gate terminal thereof connected to the source terminal thereof, a parasitic diode directed from the drain terminal to the source terminal via the back gate terminal is formed in the transistor TR131. The transistor TR131 conducts in a direction from the drain terminal to the source terminal, whereas the transistor TR131 does not conduct in a direction from the source terminal to the drain terminal.

Thus, in the second mode, though the parasitic diode is conducting in a direction from the input side to the output side in the output circuit 13, the output circuit 13 prevents a current from flowing from the input side to the output side of the output circuit 13 because the potential of the terminal po2 on the output side is higher than the potential of the terminal pB on the input side. In addition, in the second mode, the output circuit 13 prevents a current from flowing backward from the output side to the input side because the parasitic diode does not conduct in a direction from the output side to the input side in the output circuit 13.

In the second mode, the output control circuit 111 in the control circuit 11 transmits the control signal CT144 in a high state to the gate terminals of the transistors TR144 to TR146, and thereby sets the transistor TR144 in an on state and sets the transistors TR145 and TR146 in an off state. In addition, the output control circuit 111 transmits the control signal CT142 in a low state to the gate terminal of the transistor TR142, and thereby sets the transistor TR142 in an on state. In addition, the output control circuit 111 transmits the control signal CT143 in a high state to the gate terminal of the transistor TR143, and thereby sets the transistor TR143 in an off state. Accordingly, in the second mode, the output circuit 14 outputs the second signal SDD2 from the power supply line W_VDD33 via the transistors TR142 and TR141 in an on state such that the potential VDD2 is substantially the same as the potential VDD33 of the power supply line W_VDD33. Incidentally, because the transistor TR146 has the back gate terminal thereof connected to the source terminal thereof, the transistor TR146 prevents a current from flowing in a direction from the source terminal to the drain terminal in the second mode.

A description will be made of operation of each circuit in the power supply circuit 1 in a case where a lithium ion battery is mounted as a battery in the apparatus mounted with the power supply circuit 1 and the power supply circuit 1 is operating in the third mode, in and the output circuit 12 operates in the LDO mode. FIG. 5C is a diagram illustrating an example of operation in the third mode of the potential generating circuit 10. In the third mode, the voltage control circuit 112 in the control circuit 11 controls the operation of the DC-DC converter formed by the transistors TR1 and TR2 and the buffer circuits BUF1 and BUF2, in such a manner as to generate the potential VA. In addition, the output control circuit 111 prevents the terminal pB from being connected to the grounding wire W_GND, by performing opening control of the switch SW10.

In the third mode, the output control circuit 111 in the control circuit 11 transmits the control signal CT121 to the buffer circuit BUF121 such that the state of the signal output from the buffer circuit BUF121 becomes a high state. In addition, the output control circuit 111 transmits the control signal CT122 in a high state to the gate terminals of the transistors TR122 and TR123, and thereby sets the transistors TR122 and TR123 in an off state. In addition, the output control circuit 111 transmits the control signal CT126 in a high state to the gate terminals of the transistors TR126 and TR127, and thereby sets the transistors TR126 and TR127 in an off state. In addition, the output control circuit 111 transmits the control signal CT124 in a low state to the gate terminals of the transistors TR124 and TR125, and thereby sets the transistors TR124 and TR125 in an on state.

In the third mode, according to the states set in the transistors TR122 to TR127, the signal in a high state is input from the buffer circuit BUF121 to the gate terminal of the transistor TR121. In addition, in the third mode, the source terminal of the transistor TR121 is supplied with the potential VB via the terminal pB. In addition, in the third mode, the drain terminal of the transistor TR121 is supplied with the potential VDDD from the constant voltage circuit 60 via the terminal po1. Further, the back gate terminal of the transistor TR121 is supplied with the potential VB via the transistors TR124 and TR125 in an on state and via the terminal pB.

In the third mode, the transistor TR121 is set in an off state according to the states of the transistors TR122 to TR127. In addition, in the third mode, because the transistor TR121 has the back gate terminal thereof connected to the source terminal thereof via the transistors TR124 and TR125, a parasitic diode directed from the drain terminal to the source terminal via the back gate terminal is formed in the transistor TR121. In the third mode, the transistor TR121 conducts in a direction from the drain terminal to the source terminal side, whereas the transistor TR121 does not conduct in a direction from the source terminal to the drain terminal.

Thus, in the third mode, the reverse flow preventing circuit 15 including the control circuit 11 and the output circuit 12 is set in the second state in which the source terminal is supplied with the potential VB. In the second state in the third mode, though the parasitic diode is conducting in a direction from the output side to the input side in the output circuit 12, the reverse flow preventing circuit 15 prevents a current from flowing from the output side to the input side of the output circuit 12 because the potential of the terminal pB on the input side is higher than the potential of the terminal po1 on the output side. In addition, in the second state in the third mode, the reverse flow preventing circuit 15 prevents a current from flowing backward from the input side to the output side because the parasitic diode does not conduct in a direction from the input side to the output side in the output circuit 12.

In the third mode, the output control circuit 111 in the control circuit 11 transmits the control signal CT131 to the buffer circuit BUF131 such that the state of the signal output from the buffer circuit BUF131 becomes a high state. In addition, the output control circuit 111 transmits the control signal CT132 in a high state to the gate terminals of the transistors TR132 and TR133, and thereby sets the transistors TR132 and TR133 in an off state. Incidentally, operation of the output circuit 13 in the third mode is the same as in the second mode, and therefore, a description thereof will be omitted.

In the third mode, the output control circuit 111 in the control circuit 11 transmits the control signal CT144 in a high state to the gate terminals of the transistors TR144 to TR146, and thereby sets the transistor TR144 in an on state and sets the transistors TR145 and TR146 in an off state.

In addition, when the power supply circuit 1 is in the third mode and the output circuit 14 is in the current limiting mode, the output control circuit 111 transmits the control signal CT142 in a high state to the gate terminal of the transistor TR142, and thereby sets the transistor TR142 in an off state. In addition, when the power supply circuit 1 is in the third mode and the output circuit 14 is in the current limiting mode, the output control circuit 111 transmits the control signal CT143 in a low state to the gate terminal of the transistor TR143, and thereby sets the transistor TR143 in an on state.

In addition, when the power supply circuit 1 is in the third mode and the output circuit 14 is in the through mode, the output control circuit 111 transmits the control signal CT142 in a low state to the gate terminal of the transistor TR142, and thereby sets the transistor TR142 in an on state. In addition, when the power supply circuit 1 is in the third mode and the output circuit 14 is in the through mode, the output control circuit 111 transmits the control signal CT143 in a high state to the gate terminal of the transistor TR143, and thereby sets the transistor TR143 in an off state. Because the transistor TR146 has the back gate terminal thereof connected to the source terminal thereof, the transistor TR146 prevents a current from flowing in a direction from the source terminal to the drain terminal in the third mode. Operation of the output circuit 14 in the third mode is similar to that in the first mode, and therefore, a description thereof will be omitted.

A description will be made of operation of each circuit in the power supply circuit 1 in a case where a lithium ion battery is mounted as a battery in the apparatus mounted with the power supply circuit 1 and the power supply circuit 1 is operating in the fourth mode, in which the output circuit 12 operates in the DC-DC mode. FIG. 5D is a diagram illustrating an example of operation in the fourth mode of the potential generating circuit 10. In the fourth mode, the voltage control circuit 112 in the control circuit 11 controls the operation of the DC-DC converter formed by the transistors TR1 and TR2 and the buffer circuits BUF1 and BUF2, in such a manner as to generate the potential VA. In addition, the output control circuit 111 prevents the terminal pB from being connected to the grounding wire W_GND, by performing opening control of the switch SW10.

In the fourth mode, the output control circuit 111 in the control circuit 11 transmits the control signal CT121 to the buffer circuit BUF121 such that the state of the signal output from the buffer circuit BUF121 becomes a low state. In addition, the output control circuit 111 transmits the control signal CT122 in a high state to the gate terminals of the transistors TR122 and TR123, and thereby sets the transistors TR122 and TR123 in an off state. In addition, the output control circuit 111 transmits the control signal CT126 in a high state to the gate terminals of the transistors TR126 and TR127, and thereby sets the transistors TR126 and TR127 in an off state. In addition, the output control circuit 111 transmits the control signal CT124 in a low state to the gate terminals of the transistors TR124 and TR125, and thereby sets the transistors TR124 and TR125 in an on state. Incidentally, the states of the transistor TR121, the output circuit 12, and the reverse flow preventing circuit 15 in the fourth mode are the same as in the second mode, and therefore, a description thereof will be omitted.

In the fourth mode, the output control circuit 111 in the control circuit 11 transmits the control signal CT131 to the buffer circuit BUF131 such that the state of the signal output from the buffer circuit BUF131 becomes a low state. In addition, the output control circuit 111 transmits the control signal CT132 in a high state to the gate terminals of the transistors TR132 and TR133, and thereby sets the transistors TR132 and TR133 in an off state.

In the fourth mode, the signal in a low state is input from the buffer circuit BUF131 to the gate terminal of the transistor TR131, and the transistor TR131 is thereby set in an on state. In addition, in the fourth mode, the drain terminal of the transistor TR131 is supplied with the potential VB of the terminal pB, and the output circuit 13 outputs the second signal SDD2, whose potential is the potential VDD2, from the source terminal of the transistor TR131 via the terminal po2.

In the fourth mode, the output control circuit 111 in the control circuit 11 transmits the control signal CT144 in a low state to the gate terminals of the transistors TR144 to TR146, and thereby sets the transistor TR144 in an off state and sets the transistors TR145 and TR146 in an on state. In addition, the output control circuit 111 transmits the control signal CT142 in a high state to the gate terminal of the transistor TR142, and thereby sets the transistor TR142 in an off state. In addition, the output control circuit 111 transmits the control signal CT143 in a high state to the gate terminal of the transistor TR143, and thereby sets the transistor TR143 in an off state. Incidentally, because the transistors TR142 to TR144 each have the back gate terminal thereof connected to the source terminal thereof, the transistors TR142 to TR144 each prevent a current from flowing in a direction from the source terminal to the drain terminal in the fourth mode.

In the fourth mode, the gate terminal of the transistor TR141 is supplied with the potential VDD2 from the terminal po2 via the transistors TR145 and TR146 in an on state. In the fourth mode, the transistor TR141 is set in an on state when the potential of the potential VDD2 is lower than the potential of the drain terminal of the transistor TR141. When the fourth mode is set and the transistor TR141 is in an on state, the transistors TR142 and TR143 each prevent a current from flowing from the power supply line W_VDD33 to the terminal po2 via the transistor TR141 in an on state, because the conducting direction of the parasitic diode is a direction from the drain terminal to the source terminal.

In addition, in the fourth mode, the transistor TR141 is set in an off state when the potential of the potential VDD2 is higher than the potential of the drain terminal of the transistor TR141. When the fourth mode is set and the transistor TR141 is in an off state, the transistor TR141 prevents a current from flowing from the terminal po2 to the power supply line W_VDD33 via the parasitic diodes of the transistors TR142 and TR143, because the conducting direction of the parasitic diode of the transistor TR141 is a direction from the drain terminal to the source terminal.

A description will be made of operation of each circuit in the power supply circuit 1 in a case where the power supply circuit 1 is operating in the fifth mode, in which the output circuits 12 to 14 in the power supply circuit 1 operate in the standby mode. FIG. 5E is a diagram illustrating an example of operation in the fifth mode of the potential generating circuit 10. In the fifth mode, the voltage control circuit 112 in the control circuit 11 controls the operation of the DC-DC converter formed by the transistors TR1 and TR2 and the buffer circuits BUF1 and BUF2, in such a manner as to stop the generation of the potential VA. In addition, the output control circuit 111, by performing short-circuiting control of the switch SW10, causes the potential of the terminal pB to transition to the ground potential GND which is the potential of the grounding wire W_GND.

In the fifth mode, the output control circuit 111 in the control circuit 11 transmits the control signal CT121 to the buffer circuit BUF121 such that the state of the signal output from the buffer circuit BUF121 becomes a high-impedance state. In addition, the output control circuit 111 transmits the control signal CT122 in a low state to the gate terminals of the transistors TR122 and TR123, and thereby sets the transistors TR122 and TR123 in an on state. In addition, the output control circuit 111 transmits the control signal CT126 in a low state to the gate terminals of the transistors TR126 and TR127, and thereby sets the transistors TR126 and TR127 in an on state. In addition, the output control circuit 111 transmits the control signal CT124 in a high state to the gate terminals of the transistors TR124 and TR125, and thereby sets the transistors TR124 and TR125 in an off state.

In the fifth mode, according to the states set in the transistors TR122 to TR127, the gate terminal of the transistor TR121 is supplied with the potential VDDD from the constant voltage circuit 60 via the transistors TR122 and TR123 in an on state and via the terminal po1. In addition, in the fifth mode, the source terminal of the transistor TR121 is supplied with the ground potential GND via the switch SW10. In addition, in the fifth mode, the drain terminal of the transistor TR121 is supplied with the potential VDDD from the constant voltage circuit 60 via the terminal po1. Further, the back gate terminal of the transistor TR121 is supplied with the potential VDDD via the transistors TR126 and TR127 in an on state and via the terminal po1. Incidentally, the states of the transistor TR121 and the reverse flow preventing circuit 15 in the fifth mode are the same as in the first mode, and therefore, a description thereof will be omitted.

In the fifth mode, the output control circuit 111 in the control circuit 11 transmits the control signal CT131 to the buffer circuit BUF131 such that the state of the signal output from the buffer circuit BUF131 becomes a high-impedance state. In addition, the output control circuit 111 transmits the control signal CT132 in a low state to the gate terminals of the transistors TR132 and TR133, and thereby sets the transistors TR132 and TR133 in an on state.

In the fifth mode, the gate terminal of the transistor TR131 is supplied with the potential VDD2 from the output circuit 14 via the transistors TR132 and TR133 in an on state. In addition, in the fifth mode, the source terminal of the transistor TR131 is supplied with the potential VDD2 from the terminal po2. In addition, in the fifth mode, the drain terminal of the transistor TR131 is supplied with the ground potential GND via the switch SW10. Incidentally, operation of the output circuit 13 in the fifth mode is the same as in the first mode, and therefore, a description thereof will be omitted.

In the fifth mode, the output control circuit 111 in the control circuit 11 transmits the control signal CT144 in a low state to the gate terminals of the transistors TR144 to TR146, and thereby sets the transistor TR144 in an off state and sets the transistors TR145 and TR146 in an on state. In addition, the output control circuit 111 transmits the control signal CT142 in a high state to the gate terminal of the transistor TR142, and thereby sets the transistor TR142 in an off state. In addition, the output control circuit 111 transmits the control signal CT143 in a high state to the gate terminal of the transistor TR143, and thereby sets the transistor TR143 in an off state.

Because the transistors TR142 to TR144 each have the back gate terminal thereof connected to the source terminal thereof, the transistors TR142 to TR144 each prevent a current from flowing in a direction from the source terminal to the drain terminal in the fifth mode. In addition, operation of the output circuit 14 in the fifth mode is similar to that in the fourth mode, and therefore, a description thereof will be omitted.

### Flow of Series of Operation

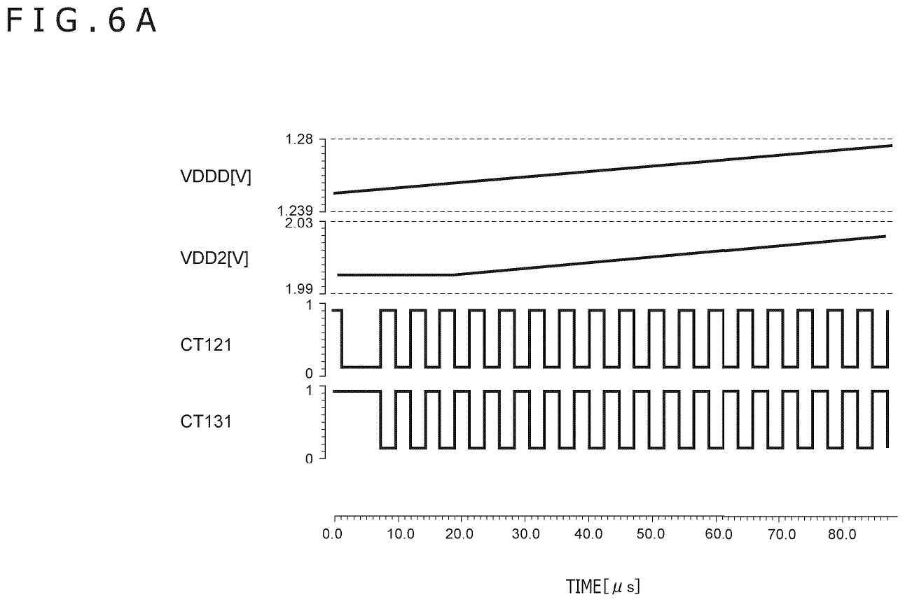

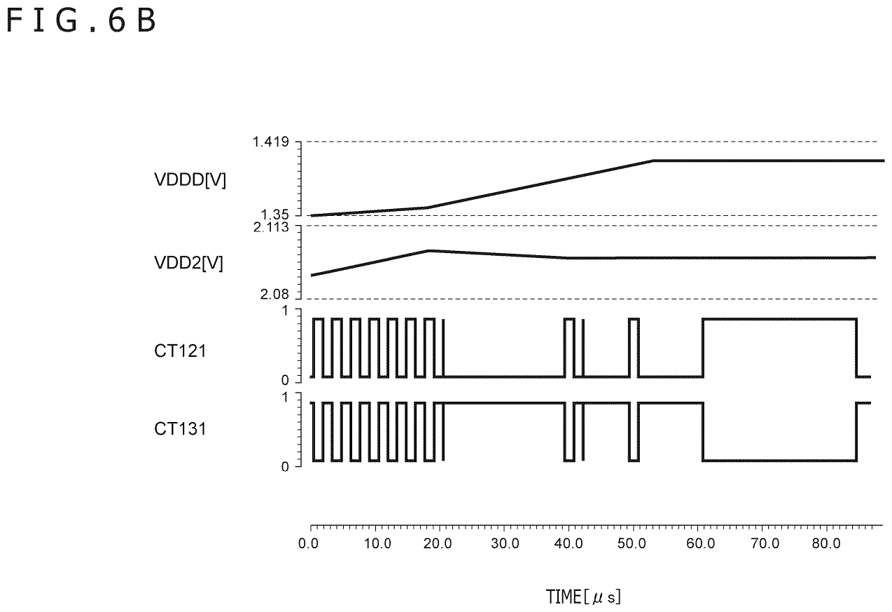

The operation of the potential generating circuit 10 in each operation mode has been described above. Transitions of the potentials of respective signals in the potential generating circuit 10 will next be described in detail. FIG. 6A is a first example of a timing diagram illustrating the states of outputs of the potential generating circuit 10. In addition, FIG. 6B is a second example of the timing diagram illustrating the states of the outputs of the potential generating circuit 10. In FIG. 6A and FIG. 6B, the control circuit 11 has set the operation mode of the power supply circuit 1 to the fourth mode, has set the first set potential to 1.4 V, and has set the second set potential to 2.1 V. In FIG. 6A, the control circuit 11 has set the operation mode of the power supply circuit 1 to the fourth mode, has set the first set potential to 1.4 V, and has set the second set potential to 2.1 V.

As illustrated in FIG. 6A, in the fourth mode, when the potential VDDD output by the output circuit 12 is lower than the first set potential and the potential VDD2 output by the output circuit 13 is lower than the second set potential, the control circuit 11 controls the states of the control signals CT121 and CT131 such that the output circuits 12 and 13 alternately perform output at fixed intervals.

As illustrated in FIG. 6B, in the fourth mode, when the potential VDDD output by the output circuit 12 is lower than the first set potential and the potential VDD2 output by the output circuit 13 is equal to or higher than the second set potential, the control circuit 11 controls the states of the control signals CT121 and CT131 to stop output by the output circuit 13 and perform output from the output circuit 12.

Though not illustrated in the figures, in the fourth mode, when the potential VDDD output by the output circuit 12 is equal to or higher than the first set potential and the potential VDD2 output by the output circuit 13 is lower than the second set potential, the control circuit 11 controls the states of the control signals CT121 and CT131 to stop output by the output circuit 12 and perform output from the output circuit 13. In addition, when the potential VDDD is equal to or higher than the first set potential and the potential VDD2 is equal to or higher than the second set potential, the control circuit 11 controls the states of the control signals CT121 and CT131 to perform output from only one of the output circuits 12 and 14.

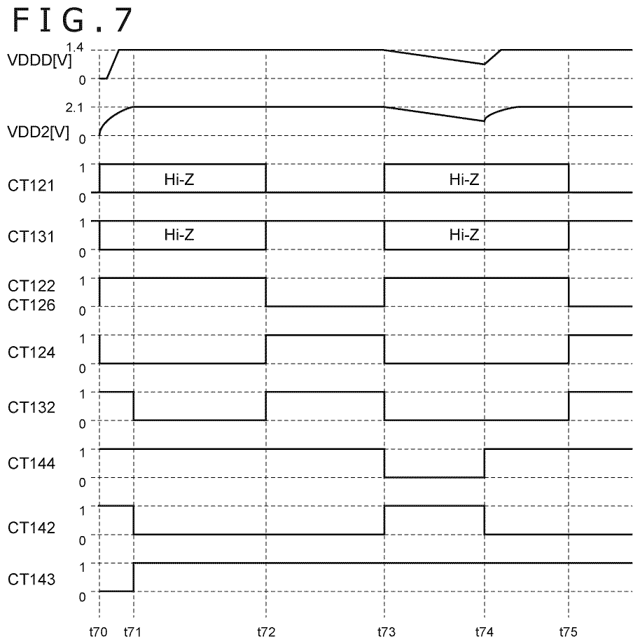

FIG. 7 is a first example of a timing diagram illustrating transitions of each signal in the potential generating circuit 10. In FIG. 7, a dry cell is mounted as a battery in the apparatus mounted with the power supply circuit 1, and the power supply circuit 1 operates while switching between the first mode, the second mode, and the fifth mode. In FIG. 7, the first set potential is set to 1.4 V. In addition, in FIG. 7, the second set potential is set to 2.1 V.

At time t70, the control circuit 11 sets the operation mode of the power supply circuit 1 to the first mode, and sets the output circuit 14 to the current limiting mode. Specifically, the control circuit 11 sets the states of the control signals CT121 and CT131 to a high-impedance state. In addition, the control circuit 11 sets the states of the control signals CT122, CT126, CT132, CT142, and CT144 to a high state. In addition, the control circuit 11 sets the states of the control signals CT124 and CT143 to a low state. The control circuit 11 outputs each of the control signals whose states are set.

At time t70, the output circuit 12 operates in the LDO mode, and stops the output of the potential VDDD. The terminal po1 is supplied with a potential by the constant voltage circuit 60, and the potential VDDD starts to make a transition to 1.4 V which is the first set potential.

At time t70, the output circuit 13 stops the output of the potential VDD2. In addition, the output circuit 14 operates in the current limiting mode, and outputs the potential of the power supply line W_VDD33 to the terminal po2 while suppressing an inrush current. The potential VDD2 of the terminal po2 starts to make a transition to 2.1 V which is the second set potential.

At time t71, the control circuit 11 sets the output circuit 14 to the through mode. Specifically, the control circuit 11 makes the states of the control signals CT132 and CT142 make a transition to a low state. In addition, the control circuit 11 makes the state of the control signal CT143 make a transition to a high state.

At time t71, the output circuit 12 operates in the LDO mode, and is stopping the output of the potential VDDD. The terminal po1 is supplied with a potential by the constant voltage circuit 60, and the potential VDDD has reached 1.4 V which is the first set potential.

At time t71, the output circuit 13 is stopping the output of the potential VDD2. In addition, the output circuit 14 operates in the through mode, and outputs the potential of the power supply line W_VDD33 to the terminal po2 in a state in which the output circuit 14 can pass a large current. The potential VDD2 of the terminal po2 has reached 2.1 V which is the second set potential.

At time t72, the control circuit 11 sets the operation mode of the power supply circuit 1 to the second mode. Specifically, the control circuit 11 sets the states of the control signals CT121, CT122, and CT142 to a low state. In addition, the control circuit 11 sets the states of the control signals CT131, CT132, CT124, CT143, and CT144 to a high state. The control circuit 11 outputs each of the control signals whose states are set.

At time t72, the output circuit 12 operates in the DC-DC mode, and outputs the potential VDDD. The terminal po1 is supplied with a potential by the output circuit 12, and the potential VDDD maintains 1.4 V which is the first set potential.

At time t72, the output circuit 13 is stopping the output of the potential VDD2. In addition, the output circuit 14 operates in the through mode, and outputs the potential of the power supply line W_VDD33 to the terminal po2 in a state in which the output circuit 14 can pass a large current. The potential VDD2 of the terminal po2 maintains 2.1 V which is the second set potential.

At time t73, the control circuit 11 sets the operation mode of the power supply circuit 1 to the fifth mode. Specifically, the control circuit 11 sets the states of the control signals CT121 and CT131 to a high-impedance state. In addition, the control circuit 11 sets the states of the control signals CT122, CT142, and CT143 to a high state. In addition, the control circuit 11 sets the states of the control signals CT124, CT132, and CT144 to a low state. The control circuit 11 outputs each of the control signals whose states are set.

At time t73, the output circuit 12 operates in the standby mode, and stops the output of the potential VDDD. The supply of the potentials from the output circuit 12 and the constant voltage circuit 60 to the terminal po1 is interrupted, and the potential of the terminal po1 decreases gradually.

At time t73, the output circuit 13 is stopping the output of the potential VDD2. In addition, the output circuit 14 operates in the standby mode, and stops the output of the potential VDD2 to the terminal po2. The potential supply of the potential VDD2 to the terminal po2 is interrupted, and the potential decreases gradually.

At time t74, the control circuit 11 sets the operation mode of the power supply circuit 1 to the first mode, and sets the output circuit 14 to the through mode. Operation of the control circuit 11 at time t74 is similar to that at time t71, and therefore, a description thereof will be omitted.

At time t74, the output circuit 12 operates in the LDO mode, and is stopping the output of the potential VDDD. The terminal po1 is supplied with a potential by the constant voltage circuit 60, and the potential VDDD starts to make a transition to 1.4 V which is the first set potential.

At time t74, the output circuit 13 is stopping the output of the potential VDD2. In addition, the output circuit 14 operates in the through mode, and outputs the potential of the power supply line W_VDD33 to the terminal po2 in a state in which the output circuit 14 can pass a large current. The potential VDD2 of the terminal po2 starts to make a transition to 2.1 V which is the second set potential.

At time t75, the control circuit 11 sets the operation mode of the power supply circuit 1 to the second mode. Operation of the control circuit 11 and the output circuits 12 to 14 at time t75 is similar to that at time t72, and therefore, a description thereof will be omitted.

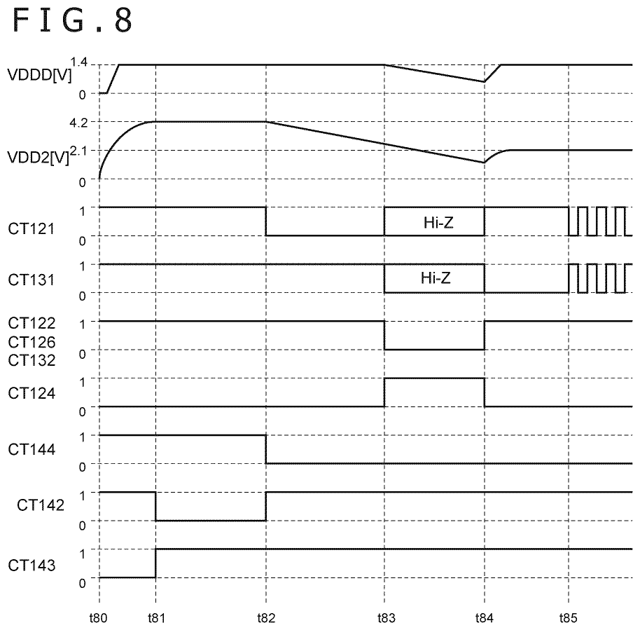

FIG. 8 is a second example of the timing diagram illustrating transitions of each signal in the potential generating circuit 10. In FIG. 8, a lithium ion battery is mounted as a battery in the apparatus mounted with the power supply circuit 1, and the power supply circuit 1 operates while switching between the third mode, the fourth mode, and the fifth mode. Incidentally, in FIG. 8, the first set potential is set to 1.4 V. In addition, in FIG. 8, the second set potential is set to 2.1 V.

At time t80, the control circuit 11 sets the operation mode of the power supply circuit 1 to the third mode, and sets the output circuit 14 to the current limiting mode. Specifically, the control circuit 11 sets the states of the control signals CT121, CT122, CT126, CT131, CT132, CT142, and CT144 to a high state. In addition, the control circuit 11 sets the states of the control signals CT124 and CT143 to a low state. The control circuit 11 outputs each of the control signals whose states are set.

At time t80, the output circuit 12 operates in the LDO mode, and stops the output of the potential VDDD. The terminal po1 is supplied with a potential by the constant voltage circuit 60, and the potential VDDD starts to make a transition to 1.4 V which is the first set potential.

At time t80, the output circuit 13 stops the output of the potential VDD2. In addition, the output circuit 14 operates in the current limiting mode, and outputs the potential of the power supply line W_VDD33 to the terminal po2 while suppressing an inrush current. The potential VDD2 of the terminal po2 starts to make a transition to 2.1 V which is the second set potential.

At time t81, the control circuit 11 sets the output circuit 14 to the through mode. Specifically, the control circuit 11 makes the state of the control signal CT142 make a transition to a low state. In addition, the control circuit 11 makes the state of the control signal CT143 make a transition to a high state.

At time t81, the output circuit 12 operates in the LDO mode, and is stopping the output of the potential VDDD. The terminal po1 is supplied with a potential by the constant voltage circuit 60, and the potential VDDD has reached 1.4 V which is the first set potential.

At time t81, the output circuit 13 is stopping the output of the potential VDD2. In addition, the output circuit 14 operates in the through mode, and outputs the potential of the power supply line W_VDD33 to the terminal po2 in a state in which the output circuit 14 can pass a large current. The potential VDD2 of the terminal po2 has reached 4.2 V which is the second set potential.

At time t82, the control circuit 11 sets the operation mode of the power supply circuit 1 to the fourth mode. Specifically, the control circuit 11 determines whether or not the potential VDDD of the terminal po1 is equal to or higher than the first set potential and whether or not the potential VDD2 of the terminal po2 is equal to or higher than the second set potential. The control circuit 11 determines that the potential VDDD of the terminal po1 is equal to or higher than the first set potential and that the potential VDD2 of the terminal po2 is lower than the second set potential. The control circuit 11 sets the states of the control signals CT121 and CT124 to a low state, and sets the state of the control signal CT142 to a high state. The control circuit 11 outputs each of the control signals whose states are set.

At time t82, the output circuit 12 operates in the DC-DC mode, and outputs the potential VDDD. The terminal po1 is supplied with the potential by the output circuit 12, and the potential VDDD maintains 1.4 V which is the first set potential.

At time t82, the output circuit 13 is stopping the output of the potential VDD2 to the terminal po2. In addition, the output circuit 14 operates in the DC-DC mode, and stops the output of the potential to the terminal po2. The supply of the potentials from the output circuits 13 and 14 is interrupted, and the potential VDD2 of the terminal po2 decreases gradually.

At time t83, the control circuit 11 sets the operation mode of the power supply circuit 1 to the fifth mode. Specifically, the control circuit 11 sets the states of the control signals CT121 and CT131 to a high-impedance state. In addition, the control circuit 11 sets the state of the control signal CT124 to a high state. In addition, the control circuit 11 sets the states of the control signals CT122, CT126, and CT132 to a low state. The control circuit 11 outputs each of the control signals whose states are set.

At time t83, the output circuit 12 operates in the standby mode, and stops the output of the potential VDDD. The supply of the potentials from the output circuit 12 and the constant voltage circuit 60 to the terminal po1 is interrupted, and the potential of the terminal po1 decreases gradually.

At time t83, the output circuit 13 is stopping the output of the potential VDD2. In addition, the output circuit 14 operates in the standby mode, and is stopping the output of the potential VDD2 to the terminal po2. The potential supply of the potential VDD2 to the terminal po2 is interrupted, and the potential decreases gradually.

At time t84, the control circuit 11 sets the operation mode of the power supply circuit 1 to the third mode, and sets the output circuit 14 to the through mode. Operation of the control circuit 11 at time t84 is similar to that at time t81, and therefore, a description thereof will be omitted.

At time t84, the output circuit 12 operates in the LDO mode, and is stopping the output of the potential VDDD. The terminal po1 is supplied with a potential by the constant voltage circuit 60, and the potential VDDD starts to make a transition to 1.4 V which is the first set potential.

At time t84, the output circuit 13 is stopping the output of the potential VDD2. In addition, the output circuit 14 operates in the through mode, and outputs the potential of the power supply line W_VDD33 to the terminal po2 in a state in which the output circuit 14 can pass a large current. The potential VDD2 of the terminal po2 starts to make a transition to 2.1 V which is the second set potential.

At time t85, the control circuit 11 sets the operation mode of the power supply circuit 1 to the fourth mode. Specifically, the control circuit 11 determines whether or not the potential VDDD of the terminal po1 is equal to or higher than the first set potential and whether or not the potential VDD2 of the terminal po2 is equal to or higher than the second set potential. When the potential VDDD of the terminal po1 is equal to or higher than the first set potential and the potential VDD2 of the terminal po2 is lower than the second set potential, the control circuit 11 sets the state of the control signal CT121 to a high state, and sets the state of the control signal CT131 to a low state. In addition, when the potential VDDD of the terminal po1 is lower than the first set potential and the potential VDD2 of the terminal po2 is equal to or higher than the second set potential, the control circuit 11 sets the state of the control signal CT121 to a low state, and sets the state of the control signal CT131 to a high state. At time t85, the control circuit 11 outputs each of the control signals whose states are set. Incidentally, at and after time t85, the potential VDDD of the terminal po1 is in the vicinity of the first set potential, and the potential VDD2 of the terminal po2 is in the vicinity of the second set potential, so that the control signals CT121 and CT131 alternate with each other.

At time t85, the output circuit 12 operates in the DC-DC mode, and outputs the potential VDDD according to the state of the control signal CT121. The terminal po1 is supplied with the potential by the output circuit 12, and the potential VDDD maintains 1.4 V which is the first set potential.

At time t85, the output circuit 13 outputs the potential VDD2 according to the state of the control signal CT131. In addition, the output circuit 14 operates in the DC-DC mode, and stops the output of the potential to the terminal po2. The potential VDD2 of the terminal po2 is supplied by the output circuit 13, and the potential VDD2 maintains 2.1 V which is the second set potential.

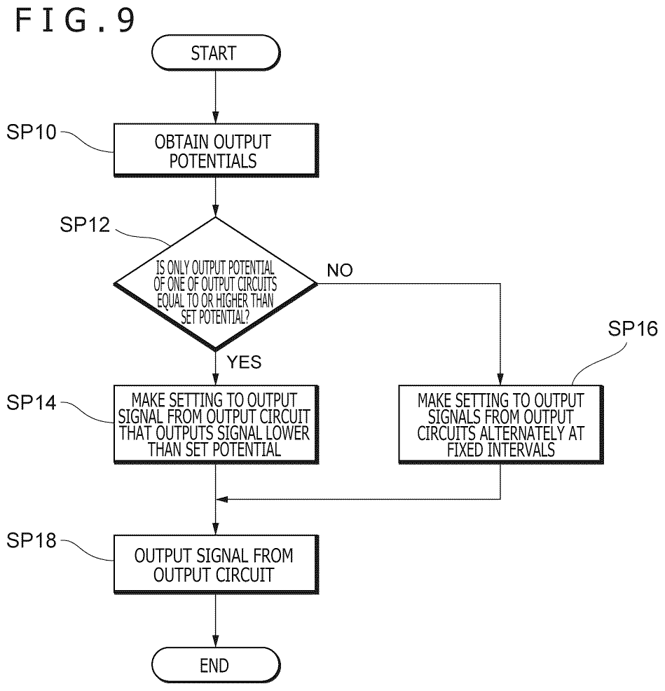

Transitions of the potential of each signal in the potential generating circuit 10 have been described above. A flow of a series of processing of the potential generating circuit 10 will next be described in detail. FIG. 9 is an example of a flowchart illustrating a flow of a series of processing of the potential generating circuit 10. In FIG. 9, a lithium ion battery is mounted as a battery in the apparatus mounted with the power supply circuit 1, and the power supply circuit 1 is operating in the fourth mode.

### Step SP10

The potential generating circuit 10 obtains the output potentials of the terminals po1 and po2. Specifically, the potential generating circuit 10 voltage-divides the potential VDDD of the terminal po1 by the variable resistances R1 and R2, and obtains the voltage-divided potential VR1. In addition, the potential generating circuit 10 voltage-divides the potential VDD2 of the terminal po2 by the variable resistances R3 and R4, and obtains the voltage-divided potential VR2. Then, the processing proceeds to the processing of step SP12.

### Step SP12

The potential generating circuit 10 determines whether or not a combination of a magnitude relation between the potential VDDD and the first set potential and a magnitude relation between the potential VDD2 and the second set potential satisfies a predetermined condition. Specifically, the potential generating circuit 10 determines whether the potential VDDD of the terminal po1 is equal to or higher than the first set potential (for example, 1.4 V) and the potential VDD2 of the terminal po2 is lower than the second set potential (for example, 2.1 V) or whether the potential VDDD of the terminal po1 is lower than the first set potential and the potential VDD2 of the terminal po2 is equal to or higher than the second set potential. Then, when the determination is a positive determination, the processing proceeds to the processing of step SP14. When the determination is a negative determination, the processing proceeds to the processing of step SP16.

### Step SP14

The potential generating circuit 10 switches an output mode to a fixed output mode to output a potential from only an output circuit that outputs the potential lower than the set potential. Specifically, in the fixed output mode, when the potential VDDD of the terminal po1 is lower than the first set potential and the potential VDD2 of the terminal po2 is equal to or higher than the second set potential, the potential generating circuit 10 outputs the potential VDDD from the output circuit 12, and stops the output of the potential VDD2 from the output circuit 13. In addition, in the fixed output mode, when the potential VDDD of the terminal po1 is equal to or higher than the first set potential and the potential VDD2 of the terminal po2 is lower than the second set potential, the potential generating circuit 10 stops the output of the potential VDDD from the output circuit 12, and outputs the potential VDD2 from the output circuit 13. Incidentally, when the potential VDDD becomes equal to or higher than the first set potential or when the potential VDD2 becomes equal to or higher than the second set potential, the potential generating circuit 10 switches the output mode from an alternating output mode to the fixed output mode at a timing of switching between the outputs of the output circuits 12 and 13. Then, the processing proceeds to the processing of step SP18.

### Step SP16

The potential generating circuit 10 switches the output mode to the alternating output mode to output potentials from the output circuits 12 and 13 alternately at fixed intervals. Specifically, in the alternating output mode, the potential generating circuit 10 performs the output of the potential VDDD from the output circuit 12 and the output of the potential VDD2 from the output circuit 13 alternately at fixed intervals. Then, the processing proceeds to the processing of step SP18.

### Step SP18

The potential generating circuit 10 outputs a potential from an output circuit on the basis of the output mode. Specifically, in the fixed output mode, the potential generating circuit 10 outputs a potential from one of the output circuits 12 and 13, and stops the output of a potential from the other. In addition, in the alternating output mode, the potential generating circuit 10 outputs a potential from one of the output circuits 12 and 13 while switching between the outputs of the output circuits 12 and 13 alternately at fixed intervals. The flow of the series of processing illustrated in FIG. 9 thereby ends.

### Effects

As described above, in the present embodiment, the potential generating circuit 10 includes the output circuit 12 (first output circuit) that outputs the first signal SDDD, the output circuit 13 (second output circuit) that outputs the second signal SDD2 different from the first signal SDDD, and the control circuit 11 that controls the output circuits 12 and 13 to make a signal output from one of the output circuits 12 and 13 according to a combination of a magnitude relation between the potential VDDD of the first signal SDDD and the first set potential and a magnitude relation between the potential VDD2 of the second signal SDD2 and the second set potential.

According to this configuration, the potential generating circuit 10 determines switching between the outputs of the output circuits 12 and 13 according to the magnitude relations of the signal potentials, and can therefore generate predetermined set potentials in a short period of time.

In addition, in the present embodiment, the control circuit 11 sets the output mode to the fixed output mode and makes the second signal SDD2 output from the output circuit 13 when the potential VDDD of the first signal SDDD is equal to or higher than the first set potential and the potential VDD2 of the second signal SDD2 is lower than the second set potential, and the control circuit 11 sets the output mode to the fixed output mode and makes the first signal SDDD output from the output circuit 12 when the potential VDD2 of the second signal SDD2 is equal to or higher than the second set potential and the potential VDDD of the first signal SDDD is lower than the first set potential.

According to this configuration, the potential generating circuit 10 preferentially makes a signal output from an output circuit that has not reached the set potential, and can therefore generate the predetermined set potentials with a low power consumption and a high efficiency (for example, a power conversion efficiency of 70.0% or more).

In addition, in the present embodiment, the control circuit 11 sets the output mode to the alternating output mode and alternately switches between the output of the first signal SDDD by the output circuit 12 and the output of the second signal SDD2 by the output circuit 13 at fixed intervals when the potential VDDD of the first signal SDDD is lower than the first set potential and the potential VDD2 of the second signal SDD2 is lower than the second set potential.

According to this configuration, the potential generating circuit 10 alternately performs output from the output circuits 12 and 13 when none of the signals output from the output circuits 12 and 13 has reached the set potential. The potential generating circuit 10 therefore can make the potentials of the plurality of signals make a transition to the predetermined set potentials equally while suppressing an imbalance.

In addition, in the present embodiment, in a case where the output mode is the alternating output mode, the control circuit 11 switches the output mode from the alternating output mode to the fixed output mode at a timing of switching between the outputs of the output circuits 12 and 13 when the potential VDDD of the first signal SDDD becomes equal to or higher than the first set potential or the potential VDD2 of the second signal SDD2 becomes equal to or higher than the second set potential.

According to this configuration, the potential generating circuit 10 switches the output mode at a timing of switching between the outputs of the output circuits 12 and 13, and can therefore suppress the occurrence of an overcurrent accompanying the switching of the output mode.

In addition, in the present embodiment, the reverse flow preventing circuit 15 includes the output circuit 12, which has a source terminal, a drain terminal, a gate terminal, and a back gate terminal, and which operates in the first state in which the ground potential GND (first potential) is supplied to the source terminal and in the second state in which the potential VB (second potential) higher than the ground potential GND is supplied to the source terminal. The output circuit 12 so configured outputs a potential supplied to the source terminal from the drain terminal on the basis of the potential of the gate terminal. The reverse flow preventing circuit 15 also includes the control circuit 11, which is connected to the gate terminal, the source terminal, and the back gate terminal. The control circuit 11, in the first state, controls the potential of the gate terminal such that the output circuit 12 stops the output and controls the potential of the back gate terminal such that the potential of the back gate terminal becomes equal to the potential of the drain terminal, and, in the second state, controls the potential of the back gate terminal such that the potential of the back gate terminal becomes equal to the potential of the source terminal.

According to this configuration, the reverse flow preventing circuit 15 connects the back gate terminal to the drain terminal when the potential of the source terminal is low, and the reverse flow preventing circuit 15 connects the back gate terminal to the source terminal when the potential of the source terminal can be high. The reverse flow preventing circuit 15 can therefore prevent a reverse flow of a current in the output circuit.

In addition, in the present embodiment, the output circuit 12 includes a first short-circuiting control circuit having two terminals, which are short-circuited in the first state and which are opened in the second state, wherein one of the two terminals is connected to the back gate terminal and the other of the two terminals is connected to the drain terminal. The output circuit 12 also includes a second short-circuiting control circuit having two terminals, which are opened in the first state and which are short-circuited in the second state, wherein one of the two terminals is connected to the in back gate terminal and the other of the two terminals is connected to the source terminal.

According to this configuration, the reverse flow preventing circuit 15 controls the connection destination of the back gate terminal of the output circuit 12 by the states of the short-circuiting control circuits, and can therefore easily control prevention of current reverse flow in the output circuit 12.

### Modifications

It is to be noted that the present disclosure is not limited to the foregoing embodiment. That is, the foregoing embodiment modified in design by those skilled in the art as appropriate is also included in the scope of the present disclosure as long as the modified embodiment has features of the present disclosure. In addition, elements included in the foregoing embodiment and modifications to be described later can be combined with one another where technically possible. Combinations of these elements are also included in the scope of the present disclosure as long as the combinations include features of the present disclosure.

For example, in the foregoing embodiment, the output circuit 14 controls conduction and non-conduction between the gate terminal of the transistor TR141 and the terminal po2 by the transistors TR145 and TR146. However, the disclosure is not limited to this configuration. The conduction and the non-conduction between the gate terminal of the transistor TR141 and the terminal po2 may be controlled by only the transistor TR146 excluding the transistor TR145.

According to this configuration, the output circuit 14 can be operated with a small number of parts. The potential generating circuit 10 can therefore generate the predetermined set potentials at a low cost and in a short period of time.

In addition, in the foregoing embodiment, the potential generating circuit 10 generates the two potentials VDDD and VDD2 by the two output circuits 12 and 13. However, the disclosure is not limited to this configuration. The potential generating circuit 10 may generate three or more potentials by three or more output circuits. In generating the three or more potentials, the potential generating circuit 10 controls each output circuit to make a signal output from an output circuit that outputs a potential that has not reached a set potential determined in advance for the respective potential. When there are a plurality of output circuits from which signals are to be output, the potential generating circuit 10 makes the output circuits output the signals alternately with each other at fixed intervals.

According to this configuration, the potential generating circuit 10 can generate three or more predetermined set potentials in a short period of time.

1. A potential generating circuit comprising:
a first output circuit configured to output a first signal;
a second output circuit configured to output a second signal different from the first signal; and
a control circuit configured to control the first output circuit and the second output circuit to make a signal output from one of the first output circuit and the second output circuit according to a combination of a magnitude relation between a potential of the first signal and a first set potential and a magnitude relation between a potential of the second signal and a second set potential.

2. The potential generating circuit according to claim 1, wherein
the control circuit
sets an output mode to a fixed output mode and makes the second signal output from the second output circuit when the potential of the first signal is equal to or higher than the first set potential and the potential of the second signal is lower than the second set potential, and
sets the output mode to the fixed output mode and makes the first signal output from the first output circuit when the potential of the second signal is equal to or higher than the second set potential and the potential of the first signal is lower than the first set potential.

3. The potential generating circuit according to claim 2, wherein
the control circuit sets the output mode to an alternating output mode and alternately switches between the output of the first signal by the first output circuit and the output of the second signal by the second output circuit at fixed intervals when the potential of the first signal is lower than the first set potential and the potential of the second signal is lower than the second set potential.

4. The potential generating circuit according to claim 3, wherein,
in a case where the output mode is the alternating output mode, the control circuit switches the output mode from the alternating output mode to the fixed output mode at a timing of switching between the outputs of the first output circuit and the second output circuit when the potential of the first signal becomes equal to or higher than the first set potential or the potential of the second signal becomes equal to or higher than the second set potential.

5. A control method of a potential generating circuit including a first output circuit and a second output circuit, the control method comprising:
determining, by the potential generating circuit, whether or not a combination of a magnitude relation between a potential of a first signal and a first set potential and a magnitude relation between a potential of a second signal and a second set potential satisfies a predetermined condition;
controlling, by the potential generating circuit, the first output circuit and the second output circuit to make a signal output from one of the first output circuit and the second output circuit when the determination is a positive determination; and
alternately switching, by the potential generating circuit, between an output of the first signal by the first output circuit and an output of the second signal by the second output circuit at fixed intervals when the determination is a negative determination.

6. A reverse flow preventing circuit comprising:
an output circuit that has a source terminal, a drain terminal, a gate terminal, and a back gate terminal and that is configured to:
operate in a first state in which a first potential is supplied to the source terminal and in a second state in which a second potential higher than the first potential is supplied to the source terminal, and
output a potential supplied to the source terminal from the drain terminal on a basis of a potential of the gate terminal; and
a control circuit connected to the gate terminal, the source terminal, and the back gate terminal and configured to:
in the first state, control the potential of the gate terminal such that the output circuit stops the output, and control a potential of the back gate terminal such that the potential of the back gate terminal becomes equal to a potential of the drain terminal; and
in the second state, control the potential of the back gate terminal such that the potential of the back gate terminal becomes equal to the potential of the source terminal.

7. The reverse flow preventing circuit according to claim 6, wherein
the output circuit includes
a first short-circuiting control circuit having first and second terminals, which are short-circuited in the first state and which are opened in the second state, wherein the first terminal is connected to the back gate terminal, and the second terminal is connected to the drain terminal, and
a second short-circuiting control circuit having first and second terminals, which are opened in the first state and which are short-circuited in the second state, wherein the first terminal is connected to the back gate terminal, and the second terminal is connected to the source terminal.
